(19) United States
(12) Patent Application Publication
(10) Pub. No.: US 2026/0030009 A1
(43) Pub. Date: Jan. 29, 2026

(54) SYSTEM AND METHOD FOR UNIFICATION OF PROPERTIES ASSOCIATED WITH ARTIFACTS

(71) Applicant: Embeddetech, Inc., Tulsa, OK (US)

(72) Inventor: Jonathan Torkelson, Tulsa, OK (US)

(21) Appl. No.: 18/970,295

(22) Filed: Dec. 5, 2024

Related U.S. Application Data
(60) Provisional application No. 63/674,965, filed on Jul. 24, 2024.

(51) Int. Cl. G06F 8/61; G06N 10/80

(52) U.S. Cl. CPC G06F 8/61; G06N 10/80

(57) ABSTRACT

A method for unification of properties associated with artifacts includes defining particles to represent the artifacts associated with one or more queries. The particles include one or more quantum properties and one or more entanglements assigned to each possible classical value of the quantum properties. Applying the entanglements either expands or constrains a configuration space corresponding to the possible classical values of the quantum properties. The quantum properties are collapsible into at least one permutation of classical values from the configuration space based on the entanglements for unification. The particles are unified based on particles and anterior entanglements specified in a request from a user device, after transitive entanglements of the particles are identified. The particles are then actualized based on the unified values. Meta-quantum mechanical paradigm used to define the particles allows the requests to be received using declarative scripting, and unified in a computationally and memory efficient manner.

### CROSS-REFERENCE TO RELATED CASES

This application claims the benefit of U.S. provisional patent application Ser. No. 63/674,965, filed on Jul. 24, 2024, and incorporates such provisional application by reference into this disclosure as if fully set out at this point.

### FIELD OF THE INVENTION

The present disclosure relates to unification of properties of artifacts which form systems with interdependent configuration. In particular, the present disclosure relates to a meta-quantum mechanical paradigm that may be used for representing and unifying properties associated with physical and/or virtual composable artifacts.

### BACKGROUND OF THE INVENTION

The following description of related art is intended to provide background information pertaining to the field of the disclosure. This section may include certain aspects of the art that may be related to various features of the present disclosure. However, it should be appreciated that this section is to be used only to enhance the understanding of the reader with respect to the present disclosure, and not as admissions of prior art.

A well-known problem known in computer science and mathematics, and systems engineering, among other fields, is the problem of unification. Unification problems involve the identification and configuration of a combination of compatible values for a plurality of variables/attributes/properties, such as those associated with one or more artifacts (which may be virtual artifacts such as software packages or libraries, or physical real-world artifacts such as an engine with properties of size, weight, and horsepower, or a digital twin thereof). For example, the variable or property may correspond to a version of a software package or a library, which may be dependent on another set of software packages (or specific versions thereof). Further, the dependencies of software packages may change based on the target domain in which they are to be installed/actualized. For example, a package may have different dependencies or configuration requirements based on an operating system of the target domain, hardware capabilities of the devices associated with the target domain, the specific features of the package that are needed, etc. Hence, versions of the software package and corresponding dependencies must be “unified” (i.e. a combination of compatible versions or property configurations for the software packages must be determined) before installing the software packages in the target domain. Similarly, (Boolean) satisfiability problems require a combination of values to be identified for satisfying a Boolean expression (which may have applications in electrical circuit design, model checking, systems engineering verification and validation, and the like).

Existing algorithms for unification, however, have several drawbacks. For example, in software package management, existing solutions such as build systems and build system generators use imperative scripting languages to incorporate and configure different versions of the packages. As an example, CMake, the most common cross-platform build system generator for C++, uses a tool-specific scripting language to allow package authors to express configurations for how a build system should be generated and configured for the package's library.

Because CMake uses imperative scripting, it is fundamentally impossible for it to properly manage dependency graph scenarios like diamond and “V” dependency graphs. For example, if Package A is dependent on Packages B and C, and Packages B and C are further dependent on Package D, the dependencies of the Package A can be represented using a diamond shaped graph. However, existing solutions are incapable of simultaneously unifying and configuring packages in such cases because for a parent package (such as Package B) of a shared dependency Package D to use and configure Package D, it must imperatively set variables targeted for use by Package D, and load Package D's CMake scripts, which process those configurations. Further, when another package (such as Package C) also depends on Package D, and Package C attempts to set variables that are read by Package D's CMake scripts with its own transitive configurations, CMake fails because it has already loaded and executed Package D's script. Before Package D's script is loaded a second time, the second parent re-sets variables that were previously set imperatively, changing the value of the variable from the value used during the first script execution. Imperative scripting provides the flexibility that allows independently authored packages to communicate and configure from a depending package to a dependency package. CMake, the build system generator, facilitates the script execution. However, this imperative script system creates script execution race conditions and fundamentally fails to allow multiple depending packages to simultaneously influence the configuration of the dependency package, wherever either a “V” or diamond dependency or configuration scenario arises. This key failure applies to all build systems and build system generators available today, not just CMake, and is a ubiquitous problem in the current state of the art.

Further, many unification problems suffer from a combinatorial exploding configuration state space. For example, a package may have 10 different versions. Each version may have two variables used to conditionally define dependencies on multiple other packages and specify configuration requirements. Those packages may then have 10 different versions, and so on. The configuration space of automatically self-orchestrating and composable systems may easily explode to extremely high numbers, with solutions that may be intractable from a memory resource or computation time standpoint.

Hence, there is a need for a solution for unifying properties of multiple artifacts having combinatorically exploding state spaces. Further, there is a need for a solution that unifies properties of the artifacts more efficiently and effectively than existing solutions that use imperative scripting approaches, delivering deterministic and so-called “consistent configuration.”

### SUMMARY OF THE INVENTION

In an aspect, embodiments of the present disclosure are directed to a method for representing aspects of artifacts for unification and actualization of the artifacts. The method includes defining, by a processor, one or more particles to represent one or more artifacts associated with one or more queries. The particles include one or more quantum properties that are configured to be in a superposition of one or more possible classical values in a corresponding configuration state space. The particles also include one or more entanglements assigned to each possible classical value of the one or more quantum properties, wherein applying the one or more entanglements either expands or constrains the state space. The particles further include wherein the one or more quantum properties are collapsible into at least one permutation from a set of permutations of one or more classical values from the state space based on the one or more entanglements. The method includes storing/transmitting the one or more particles for unification of the one or more quantum properties into the at least one permutation and actualization of the one or more artifacts based on the at least one permutation.

Another aspect of the present disclosure is directed to a method for representing aspects of artifacts for unification and actualization of the artifacts. The method includes receiving, by a processor, a request from a user for unification of one or more predefined particles associated with one or more activities on a target domain. The request includes one or more anterior logical entanglements associated with one or more first quantum properties of the one or more predefined particles. The method includes identifying one or more transitive entanglements corresponding to dependencies of each of the one or more predefined particles based on the one or more anterior logical entanglements, wherein the one or more transitive entanglements entangle at least one possible classical value associated with the one or more first quantum properties to one or more second quantum properties associated with one or more dependency particles. The method includes unifying the one or more predefined particles and the one or more dependency particles to determine at least one valid or internally consistent permutation of one or more classical values for the one or more first quantum properties and the one or more second quantum properties, where all entanglements are satisfied. The method further includes actualizing the one or more predefined particles and the one or more dependency particles in the target domain based on the at least one permutation.

In some embodiments, the aforementioned methods may be implemented by a corresponding system having a processor and a memory storing processor-executable instructions. In further embodiments, the aforementioned methods may be stored as instructions in a corresponding computer-readable medium.

Other aspects of the disclosure will be apparent from the following description and the appended claims.

### BRIEF DESCRIPTION OF THE DRAWINGS

FIG. 1 illustrates a network architecture with a system for creating and unifying and actualizing particles representing artifacts, according to embodiments of the present disclosure.

FIGS. 2A to 2C illustrate example representations of particles corresponding to artifacts, according to embodiments of the present disclosure.

FIG. 2D illustrates a flowchart of an example method for representing aspects of artifacts for unification and actualization of the artifacts, according to embodiments of the present disclosure.

FIG. 3 illustrates a flowchart of an example method for unification of particles corresponding to a high-level user request, according to embodiments of the present disclosure.

FIGS. 4A to 4D illustrate example unification requirements trees, according to embodiments of the present disclosure.

FIGS. 5A and 5B illustrate example dependency graphs generated from the unification requirement trees, according to embodiments of the present disclosure.

FIG. 6 illustrates example permutations of classical values of the particles having anterior logical entanglements, according to embodiments of the present disclosure.

FIGS. 7A and 7B illustrate example permutations of classical values of particles having anterior logical entanglements and transitive entanglements, according to embodiments of the present disclosure.

FIGS. 8A to 8C illustrate example particle entanglement maps, according to embodiments of the present disclosure.

FIG. 8D illustrates an example representation of posterior entanglements using identity entanglements, according to embodiments of the preset disclosure.

FIG. 9 illustrates in which or with which embodiments of the system may be implemented, according to embodiments of the present disclosure.

### DETAILED DESCRIPTION OF THE PREFERRED EMBODIMENTS

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the present disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Throughout the specification, the terms “unify,” “unification”, “configuration”, or any variations thereof mean and include determination of one or more combinations/permutations of possible values of (quantum) properties of one or more artifacts/particles can have.

Throughout the specification, the terms “actualize,” “actualization”, or any variations thereof mean and include at least one of installing, orchestrating, configuring, realizing, manufacturing, executing decisions, transmitting signals, and the like, but not limited thereto, of artifacts based on unified values of corresponding particles. For example, to “actualize the particles” when the particles correspond to software packages means to install the software packages.

### INTRODUCTION

The present disclosure relates to unification of properties of artifacts/assets. To “unify” refers to the determination of a combination of values for the artifacts such that when the artifacts are actualized (such as when software packages are installed), the artifacts are compatible with each other and properly configured. In particular, the present disclosure relates to a meta-quantum mechanical paradigm that may be used for representing and unifying properties associated with physical and/or virtual artifacts. In the meta-quantum mechanical paradigm, quantum properties of particles corresponding to the artifacts may be in a state of quantum superposition, until the particles' properties are collapsed to specific values based one or more (logical) entanglements. The entanglements may recursively necessitate the creation of additional particles with corresponding properties and possible states for the artifacts.

The entanglements may be transitive entanglements, which may capture inherent dependencies or configuration requirements between two or more quantum properties. The entanglements may also correspond to anterior requirements of a user provided in the form of a request (an anterior entanglement). The meta-quantum mechanical paradigm allows the request to be expressed in a declarative manner, i.e. allow requirements/logic to be described without control flow or sequential steps as required by existing solutions that use imperative scripting. Entanglements may either specify loose requirements of property values to allow flexibility and compatibility with other requirements, or narrow or strict requirements of property values, as appropriate.

Embodiments of the present disclosure also relate to unification of the quantum properties of the particles to a compatible classical state. The particles may be unified by determining a set of possible combinations/permutations of possible values that the quantum properties can take, and identifying one or more permutations from the set of permutations that are consistent/compatible with the entanglements associated with the particles.

The embodiments of the present disclosure unify and actualize the meta-quantum mechanical representations of the artifacts using the platform. The particles may be independently developed, and any dependencies thereof may be represented using the logical entanglements, thereby allowing the artifacts to be composable and/or self-orchestrating (i.e. actualizable without requiring dependencies for each application to be predetermined). Further, the meta-quantum mechanical characteristics of the paradigm enable problems having combinatorically exploding configuration space permutations to be practically unified.

The embodiments of the present disclosure herein are further designed to facilitate interaction between developers/developer entities (who create the artifacts) and users/user entities (who use or consume the artifacts) over a platform/ecosystem. For example, the platform may be implemented to function as a central management point both for software vendors/content developers and for the users. Additionally, the embodiments described herein provide governance with respect to creation and hosting of particles by the developers, and unification of particles by the users. For example, policy requirements, such as software package licensing requirements, may be resolved concurrently with the unification of the problem. A particle creator may depend upon, entangle with, and configure a third particle party which the original particle creator may not have distribution rights to. However, the system is used to both assert the policy requirements of the third-party particle and orchestrate the particle, creating powerful network effects with zero transaction costs.

### Example Architecture of Unification System

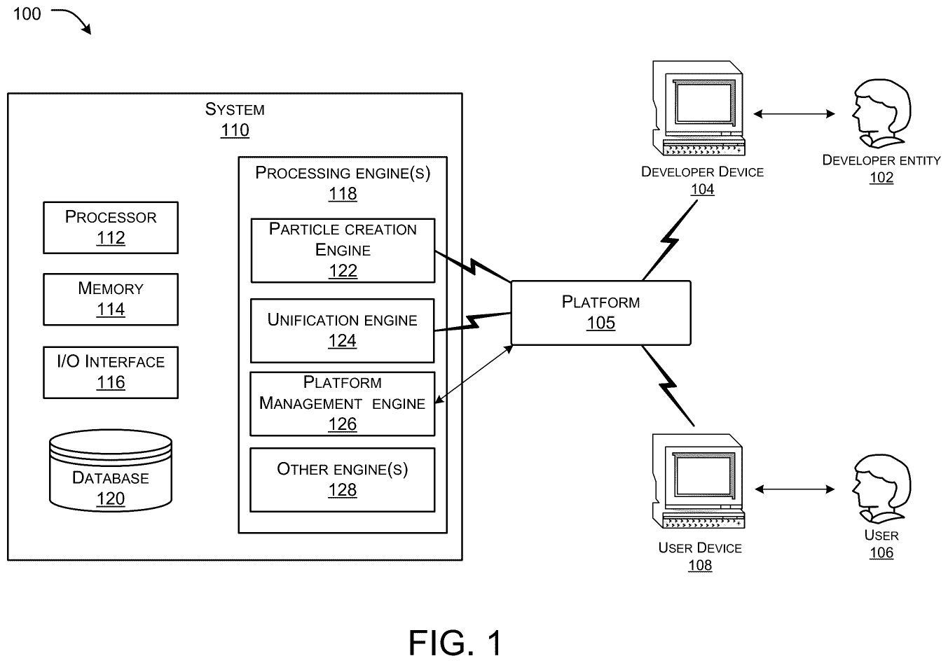

Referring to FIG. 1, an exemplary network architecture 100 includes a particle generation and unification system 110 (also referred to as system 110), which may host a platform 105 to facilitate creation of particles by developers/developer entities 102 and unification of the particles by users/user entities 106. The developers 102 may be any of including, but not limited to, a subject-matter expert, a content contributor, a company, a software vendor, an organization, a licensor, a distributor, a software claim approver, a datacenter, a business enterprise, or any other secured facility, and the like, for example. The users 106 may be any end-user (including the developers 102) intending to actualize one or more of the particles (such as install software packages corresponding to the particles, for example) developed by the developers 102. While only one user 106 and one developer 102 are shown in FIG. 1, it may be appreciated by those skilled in the art that the platform 105 may be configured to service any number of developers 102 and users 106.

The developers 102 and the users 106 may use corresponding developer devices 104 and user devices 108, respectively, for interacting with each other and the system 110 over the platform 105. The developer devices 104 and user devices 108 may be implemented using any computing device. Further, the system 110 may also be implemented using any computing device. The computing device may be any one or combination of including, but not limited to, any electrical, electronic, electro-mechanical or an equipment or a combination of one or more of the above devices such as mobile phones, smartphones, tablets, phablets, Virtual Reality (VR) devices, Augmented Reality (AR) devices, laptops, general-purpose computers, desktops, Personal Digital Assistants (PDAs), tablet computer, mainframe computer, microcomputer, servers, quantum computers, or any other computing device, and the like. Further, the computing devices may include one or more data acquisition hardware and control equipment such as, but not limited to, pumps, compressors, machines, manufacturing equipment, sensors, and the like. The computing devices may be configured to communicate with the system 110 using a set of executable instructions residing on any operating system. In some embodiments, the computing devices may also be configured as a part of another system. For example, the user device 108 may be configured to a Vehicle Control Unit (VCU) of an autonomous vehicle, which controls the vehicle based on inputs from the user 106 and/or automatically based on sensor data from vehicular sensors.

The platform 105 may be coupled to and operated by the system 110 (or the entity that owns the system 110). In some embodiments, the system 110 may be configured to communicate with the user devices 108 and the developer devices 104 through the platform 105, via a communication network (not shown). The communication network may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The communication network may include by way of example, but not limited to, one or more of, a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, some combination thereof, and the like.

The system 110 may be configured to, among other functions, enable developers 102 to develop/create particles, and/or enable the user devices 108 to unify one or more properties of multiple particles through the platform 105 for actualizing the particles (such as installing software packages, or taking autonomous navigational decisions in the autonomous vehicles corresponding to the particles). The particles may correspond to representations of one or more artifacts, and one or more aspects of the particles may be represented as one or more properties of the particles. The particles may be defined in a meta-quantum mechanical paradigm, as described subsequently in the present disclosure. The developers 102 may use the developer devices 104 to create and store/host particles corresponding to artifacts in the platform 105. The particles may be created as meta-quantum mechanical representations of the artifacts, which allow for efficient unification based on the requirements of the users 106. The user devices 108 may transmit requests that require unification of one or more of the particles created by the developers 102. The system 110 may receive the requests from the user devices 108, determine a combination of values for the properties of the particles that satisfy/are compatible with the requirements specified in the request, and actualize the particles based on such combinations of values. Further, the system 110 may be configured to enforce policy requirements (both user side policy requirements as well as developer side policy requirements) on the platform 105 after unification/quantum decoherence, but before actualization. The system 110 may include a plurality of components that enable the system 110 to perform the aforementioned functions, as described below.

In some embodiments, the system 110 may include one or more processors 112. The processors 112 may be implemented as one or more microprocessors, microcomputers, microcontrollers, digital signal processors, central processing units, logic circuitries, quantum variational circuits, quantum processors, and/or any devices that process data based on operational instructions. Among other capabilities, the processors 112 may be configured to fetch and execute computer-readable/processor-executable instructions stored in a memory 114 of the system 110. The memory 114 may be configured to store one or more computer-readable instructions or routines in a non-transitory computer-readable storage medium, which may be fetched and executed to create or share data packets. The memory 114 may include any non-transitory storage device including, for example, volatile memory such as Random Access Memory (RAM), or non-volatile memory such as Erasable Programmable Rean Only Memory (EPROM), flash memory, and the like.

In some embodiments, the system 110 may include an interface(s) 116. The interface(s) 116 may include a variety of interfaces, for example, interfaces for data input and output devices, referred to as input/output (I/O) devices, storage devices, and the like. The interface(s) 116 may facilitate communication of the system 110. The interface(s) 116 may also provide a communication pathway for one or more components of the system 110. Examples of such components include, but are not limited to, processing engine(s) 118 and a database 120.

In some embodiments, the system 110 may be communicatively coupled to one or more databases, such as database 120. The database 120 may be implemented either within the system 110, or may be implemented external to the system 110. The database 120 may be used to store/host the particles generated by the developers 102. The database 120 may be accessible by the developers 102 and/or the users 106 through the platform 105.

The processing engine(s) 118 may be implemented as a combination of hardware and programming (for example, programmable instructions) to implement one or more functionalities of the processing engine(s) 118. In examples described herein, such combinations of hardware and programming may be implemented in several different ways. For example, the programming for the processing engine(s) 118 may be processor-executable instructions stored on a non-transitory machine-readable storage medium and the hardware for the processing engine(s) 118 may include a processing resource (for example, one or more processors), to execute such instructions. In the present examples, the machine-readable storage medium may store instructions that, when executed by the processing resource, implement the processing engine(s) 118. In such examples, the system 110 may include the machine-readable storage medium storing the instructions and the processing resource to execute the instructions, i.e. the machine-readable storage medium may be separate but accessible to the system 110 and the processing resource. In other examples, the processing engine(s) 118 may be implemented by electronic circuitry.

The processing engine 118 may include one or more engines selected from any of a particle creation engine 122, a unification engine 124, a platform management engine 126, and other engines 128. In some engines, the particle creation engine 122 may be configured to allow developers 102 to create/define particles corresponding to one or more artifacts. In other embodiments, the particle creation engine 122 may be configured to translate/convert/automatically generate particles based on properties of the artifacts. The particles may be created in the meta-quantum mechanical paradigm. In some embodiments, the unification engine 124 may be configured to unify one or more properties of the particles to a compatible combination of values, as described in detail subsequently in the present disclosure.

The platform management engine 126 may be configured to implement and manage the platform 105, as disclosed in various embodiments of the present disclosure. In some embodiments, the platform management engine 126 may be configured to receive instructions/signals from the developers 102 for creating new particles with a set of properties corresponding to one or more aspects of the artifacts. The platform management engine 126 may be configured to redirect such instructions/signals to the particle creation engine 122 for creation of the specified particles. The particles may also be stored in the database 120 and may be made available on the platform 105 for the user devices 108 to access. In some embodiments, the platform management engine 126 may be configured to provide an ecosystem or a marketplace for offering the particles to the users 106. Further, the platform management engine 126 may also receive requests from the user devices 108 for the actualization of the particles previously defined by the developers 102, which may be redirected to the unification engine 124 through the platform 105 for unification. The platform management engine 126, hence, may provide a two-sided platform for the developers 102 and the users 106 to interact with each other for transacting with regard to the particles. The platform management engine 126 may allow for different independently developed particles to be integrated and used in the platform 105, while also allowing existing ecosystems/platform hosting similar types of artifacts to be translated into the meta-quantum mechanical paradigm and integrated into the platform 105 as described subsequently in the present disclosure. In some embodiments, the platform management engine 126 may also be configured to enforce one or more policy requirements associated with the particles, and/or the operation of the platform 105, as described subsequently in the present disclosure.

While FIG. 1 shows the system 110 being implemented separately or externally to the developer device 104 or the user device 102, it may be appreciated by those skilled in the art that the system 110 may be implemented with different configuration based on requirements and computing device capabilities. In some embodiments, portions of the system 110 may be implemented with either the developer device 104 or the user device 108. For example, the particle creation engine 122 may be implemented in the developer device 104 and the unification engine 124 may be implemented within the user device 108. Further, while FIG. 1 illustrates implementations where the system 110 is operated in an environment where the developers 102 and the users 106 deliberately provide instructions for creation and unification of particles, the system 110 may also be implemented as a part of other systems, such as in an autonomous vehicle, a manufacturing equipment in a manufacturing plant, IoT devices, embedded systems, electrical/logical circuits, and the like, but not limited thereto, where at least some of the particles may be created and unified autonomously.

### Meta Quantum Mechanical Paradigm

As stated above, the system 110 may be configured to enable creation of particles, such as by using the particle creation engine 122. The particles may correspond to physical or virtual artifacts. For example, the virtual artifacts may correspond to software libraries or packages, digital assets, digital twins of machines or real-world artifacts, computing environments, databases, simulations, games, and the like. Physical artifacts may correspond to machines, manufacturing equipment, (autonomous) vehicles, Internet of Things (IOT) devices, manufacturing equipment, control units associated with other systems, embedded systems, centralized or distributed servers, edge computing devices, power distribution systems, electronic circuits, and the like.

Properties associated with the particles may be used to represent aspects of such artifacts. For example, aspects of software libraries may include available versions, dependencies, computing environment in which they are operational, runtime frameworks they are compatible with, and the like. Aspects of physical artifacts may include, but not be limited to, hardware capabilities, operational parameters (such as raw materials and energy consumed, temperature to be maintained by a manufacturing equipment, for example), and the like. In some embodiments, multiple artifacts may be interdependent on each other, i.e. aspects of one artifact may influence aspects of other artifacts. For example, a first software package may be dependent on a second software package, with specific configuration requirements of the second software package. Further, each available version of the first software package may be dependent on a corresponding version(s) of the second software package. In such examples, a unified version or other quantum configuration property of the first software may entangle with a quantum configuration variable of a second software package. In other examples where the system 110 is implemented in autonomous vehicles, inclination and terrain of a road may affect the torque required to be exerted by the vehicle to maintain a speed desired by the users 106.

The particles may be created in a meta-quantum mechanical paradigm. The paradigm may provide the particles with a set of characteristics that allow for determination of one or more possible classical values that each property of the particle (and correspondingly each aspect of the artifacts) can have in a manner that is consistent with the requirements of the user 106. In the meta-quantum mechanical paradigm, both the postulated existence of particles and the values of their properties remain in a state of superposition until the particles are collapsed to unify the properties of the particles to specific classical values, producing a classical or “real” actualizable system. Because properties of particles exist in quantum superposition, and one specific value of one or more quantum properties form the quantum context for entanglements, and those entanglements predicate other quantum properties and thus postulate the existence of those particles, which may further specify transitive entanglements, the meta-quantum mechanical paradigm is needed to understand and solve this complexity. Further, the paradigm may allow the users 106 to formulate requests/requirements in a declarative manner, referencing only the particles and properties the users 106 are aware of. The users 106 do not need to understand the potentially deeply transitive implications of the request, thereby eliminating the need for each step for unification to be envisioned by the user 106 with manually resolved conflicts.

### Particle Creation

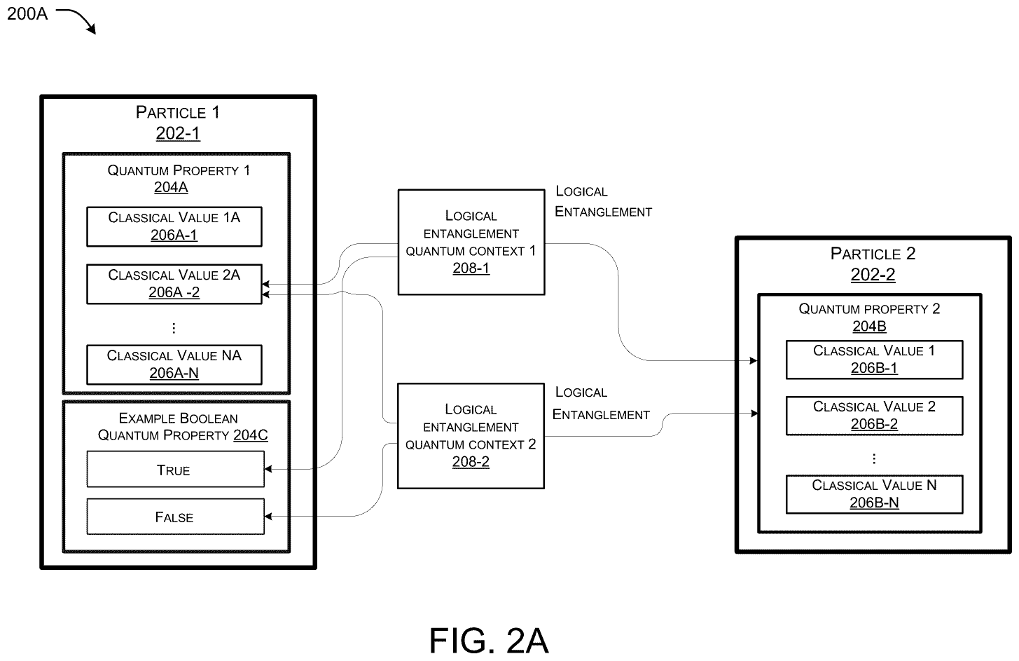

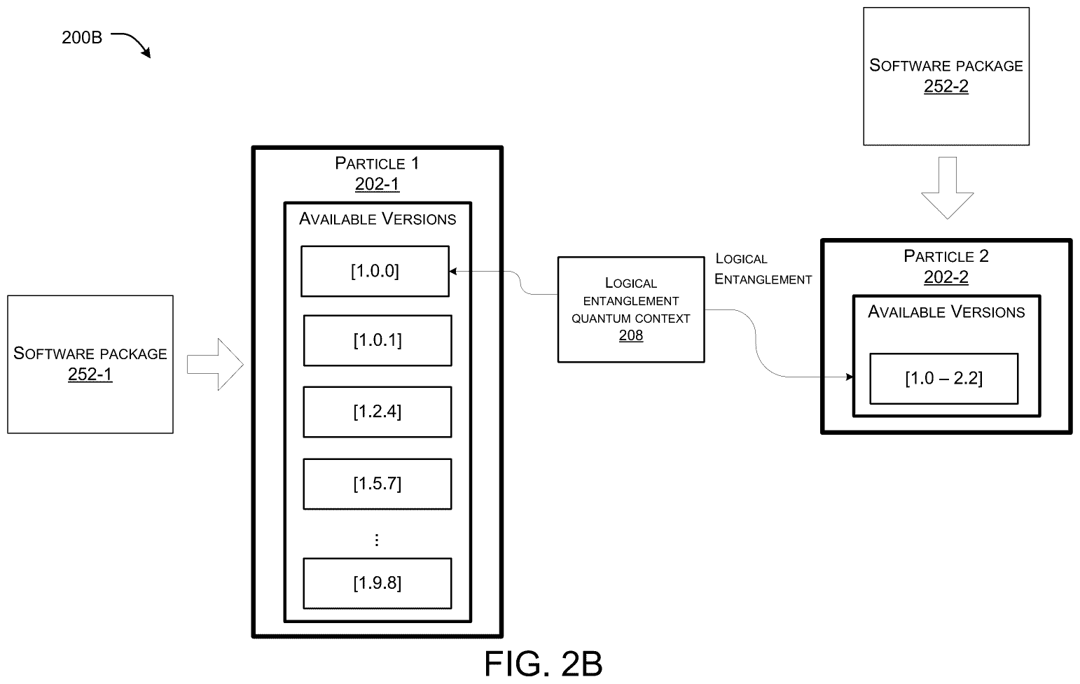

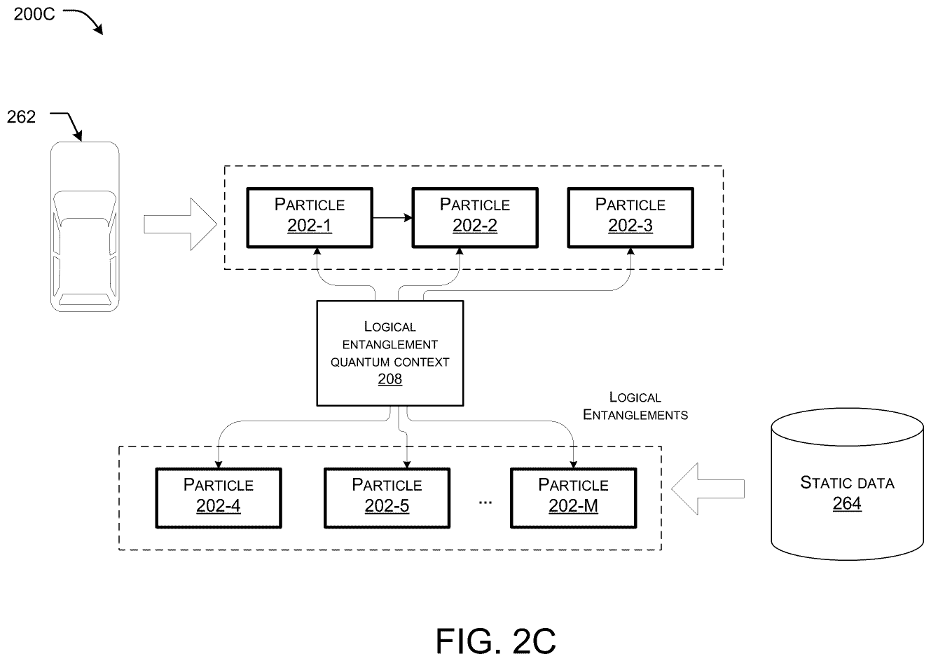

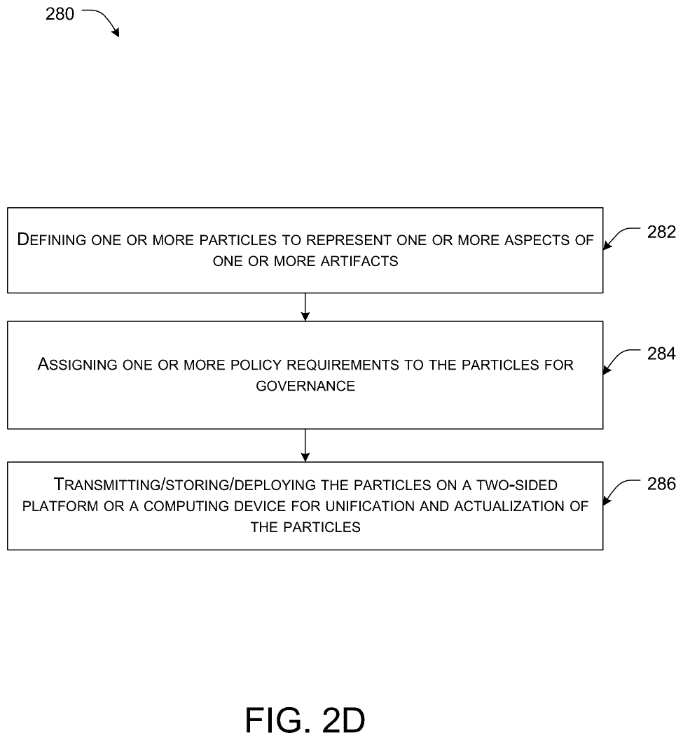

FIGS. 2A to 2C illustrate example representations of particles corresponding to artifacts, according to embodiments of the present disclosure.

With reference to FIG. 2A, in the meta-quantum mechanical paradigm, the particles, such as particles 202-1, 202-2 (collectively referred to as particles 202), may have one or more quantum properties, such as quantum properties 204A, 204B and 204C (collectively referred to as quantum properties 204), associated therewith (as shown in block representation 200A of FIG. 2A). The quantum properties 204 may take any one of one or more possible classical values, such as classical values 206A-1 to 206A-N, and 206B-1 to 206B-N (which are collectively referred to as classical values 206), when resolved and/or unified. The classical values 206 may be any of including, but not limited to, discrete or continuous numerical values, sets, objects, words/syntaxes used in natural language or scripting languages, data structures, symbols, images, digital assets, source code, precompiled assemblies, applications, and the like. Each of the quantum properties 204 may take any one classical value from the possible classical values 206. The ‘range’/′set′ of possible classical values 206 may be defined by the developer 102 or a subject matter expert, or automatically by the particle creation engine 122. The classical values may also correspond to Boolean values ‘True’ and ‘False’, which may indicate the need or lack thereof of a feature associated with the artifact, for example.

For unifying the particles 202, the user 106, using the user device 108, may define one or more logical entanglement quantum context, such as logical entanglement quantum contexts 208-1, 208-2 (hereafter referred to as quantum context 208). The quantum contexts 208 may be associated with one corresponding classical value 206 for a subset of quantum properties 204 of the particles 202. The quantum contexts 208 may apply when the quantum properties 204 of the particles 202 have the specific classical values 206 that the quantum context 208 is associated with. For example, the first quantum context 208-1 may be applicable only when the first quantum property 204A is reduced/collapsed to classical value 206A-2 and the quantum property 204C is reduced/collapsed to classical value “True”. Further, the second quantum context 208-2 may be applicable only when the first quantum property 204A is reduced/collapsed to classical value 206A-2 and the quantum property 204C is reduced/collapsed to classical value “False”. Each of the quantum contexts 208 may have a corresponding set of logical entanglements associated therewith, which are indicative of transitive dependencies of the first particle 202-1 on other particles (such as second particle 202-2), when one of the quantum contexts 208 is applicable. For example, when the first quantum context 208-1 is applicable, i.e. when the first particle 202-1's quantum properties 204A and 204C are collapsed to classical values 206A-2 and “True”, respectively, the logical entanglement quantum context 208-1 may apply a dependency on the quantum property 204B of the second particle 202-2. Similarly, when the second quantum context 208-2 is applicable, the quantum context may apply a dependency on the same quantum property 204B of particle 202-2.

One or more entanglements may be applied to each quantum property 204 as the entanglement predicate, and each entanglement on the quantum property 204 may be specified in the quantum context 208. The logical entanglement, which both requires the existence of the particle 202 with the predicated quantum property 204 and, in general, constrains the range of acceptable classical values 206 of the quantum property 204, is said to only apply when the quantum properties 204 of the quantum context 208 match the classical values 206 specified for the quantum context 208. Since those quantum properties 204 may be in a quantum superposition prior to unification, the entanglement itself also exists in quantum superposition.

These logical entanglements, which may be specified by the user 106, express the desire for the existence of a particle 202, with classical values 206 of the quantum properties 204 of the desired particle 202 to be either loosely or tightly constrained as predicates of the logical entanglement. User-issued logical entanglements, referred to as “anterior” entanglements, specifying the particle 202 and quantum property 204 to be entangled, and the entangling logic having no prior entanglement context, i.e., the anterior entanglements may always apply.

In some embodiments, the quantum context 208 (and corresponding logical entanglements) may be applicable when the quantum properties 204 of the particles 202 take any classical value 206 from a range of classical values. In an example 200B shown in FIG. 2B, first and second software packages 252-1 and 252-2 may be represented using first particles 202-1 and second 202-2, respectively. Further, aspects, such as “available versions”, of the software packages 252-1, 252-2 may be represented using the quantum properties 204 of the respective particles 202-1, 202-2. The available versions of the first particle 202-1 may have possible classical values 206 such as 1.0.0, 1.0.1, 1.2.4, 1.5.7, . . . and 1.9.8, and available versions of the second particle 202-2 may take discrete numeric values 1.0 and 2.3. In the example shown, the quantum context 208 may be applicable, when the version of the first particle 202-1 collapsed to a version that is strictly less than 1.5.6. In such examples, the transitive dependencies indicated by the logical entanglement associated with the quantum context 208 may apply. In another example, aspects of the artifacts corresponding to electrical/logical circuits or activation/deactivation of features may be quantum Boolean values, which may be represented using quantum properties 204 that take one of two possible classical values 206. In the quantum context 208 of each classical value 206 of the quantum property 204, additional entanglements may be specified. In further examples, aspects of artifacts corresponding to factories may include variables such as cost of production, cost of raw materials, demand, and the like, where each aspect may be represented using a combination of quantum properties 204 of multiple particles 202.

In yet another example, the artifact may correspond to an autonomous vehicle 262, that identifies routes between two locations provided by the occupant/user 106. For navigation, the vehicle 262 may be configured to take any one of a plurality of navigational decisions based on dynamic data (such as speed, Global Position System (GPS) position, weather and environmental, and other sensor data from the vehicle 262), and static data 264 (such as map data, vehicle 262 capabilities, and the like). Each type of data may be represented using a set of particles (such as particles 202-1 to 202-N) each having a quantum property 204 for a corresponding variable in the data. The vehicle 262 may be configured to unify the variables in the data (which may have combinatorically exploding state spaces) to make navigational decisions (such as to turn left, drive at a certain speed, switch gears, etc.) The quantum properties 204 may allow each aspect of the artifact to be represented independently of the other (except for those aspects that are “logically entangled”, as described subsequently in the present disclosure). Further, the use of particles 202 with configurable quantum properties 204 may allow for “Aspect-oriented programming” (AOP), that enables the aspects of the artifacts to be independently developed at scale, and then used together as hierarchically packaged capabilities.

In some embodiments, each of the quantum properties 204 may be represented as a set S∈{1, 2, 3 . . . , N}. The set notation represents “state space” or “configuration space” of the particle 202. The possible classical values 206 (or “states”) of the quantum properties 204 may be combined to form a state space or configuration space. The state space may include all possible combinations/permutations of classical values 206 of the quantum properties 204 that the particle(s) 202 may have. For example, a particle 202 corresponding to a single playing card may have two quantum properties 204, viz. “suit” and “rank”. Possible classical values 206 of the suit property may be represented as Suits={“Hearts”, “Diamonds”, “Spades”, “Club”} and the rank property may be represented as Rank={“Ace”, 2, 3 . . . 10, “Jack”, “Queen”, “King”}. The permutations of possible classical values 206 may be represented as a cartesian product of the two quantum properties 204, which may be represented as Ω={(“Ace”, “Hearts”), (2, “Hearts”) . . . (“Queen”, “Club”), (“King”, “Club”)}, where each permutation (denoted by σ) in the set of permutations 22 refers to the set of all permutations or the state space of the particle 202. In some embodiments, the quantum properties 204 may also be represented as distinct dimensions of a cartesian plane, where each coordinate in the cartesian plane corresponds to a unique permutation of the possible classical values 206 of the quantum properties 204.

The relationship between the quantum properties 204 of one or more of the particles 202 may be represented using “(logical) entanglements”. Logical entanglements may be assigned to a quantum property 204, and the logical entanglement may define/be associated with the quantum context 208 by referencing one of the specific classical values 206 of one or more the quantum properties 204. The logical entanglement thus only applies in quantum possibilities/permutations where the classical values 206 of the quantum properties 204 referenced in the quantum context 208 match the classical value 206 indicated in the quantum context 208. The logical entanglements may define restrictions/constraints on the state space formed by the combination of the quantum properties 204. The logical entanglements may also be used to specify requirements for a given use case. For example, dependencies between two software packages 252 may be defined using logical entanglements, as shown in FIG. 2B. In another example, the relationship between the quantum properties 204 of the particles 202 associated with the vehicle 262 and the static data may be represented using a plurality of logical entanglements as shown in example 200C of FIG. 2C. The logical entanglements may originate and terminate between quantum properties 204 of the same particles 202 (i.e. locally entangled), or quantum properties 204 of different particles 202. In some embodiments, the logical entanglements may correspond to logical operators, constraints, or any other function that transforms the quantum state of the one or more particles 202 associated with the artifacts.

In the meta-quantum mechanical paradigm described herein, the particles 202 may define the quantum property 204 in the “posterior context” of a specific classical value 206 of another quantum property 204. For example, a particle version may represent a library which, when “actualized”, results in the generation of a library project and source code corresponding to the library. A specific version of the library may specify a quantum configuration property (such as quantum properties 204) which controls how the project is generated. For example, if a Boolean property associated with the library is enabled, additional source code is added to the library, or additional entanglements on other second libraries are applied on either the version of the second library or other quantum configuration properties (such as other quantum properties 204) of the second library. The meta-quantum mechanical paradigm may allow library versions to be resolved while enabling consistent configuration of complex configuration possibilities that can be clearly understood only in a quantum conceptualization, in some examples.

Entanglements may either expand or contract/constrain the state space of the particles 202. In some embodiments, the logical entanglements may expand the state space. For example, when two quantum properties 204 corresponding to suits and rank of a playing card are logically entangled, the state space associated with the two quantum properties (which is 4 and 13 respectively) expands to 52. In such embodiments, the size of permutations, and correspondingly the complexity for unifying the classical values 206 of the quantum properties 204 grows as the number of quantum properties 204 (and number of possible classical values 206) increases. In other embodiments, applying logical entanglements contract or constrain the state space, such as when the logical entanglement requires the suit property to have the letter ‘d’ (which as formal logic could be written as “S_{d}={w∈S: contains_d(w)}”), whereby the state space is reduced from 4 to 2 (viz. Suits={“Diamonds”, “Spades”}). In such embodiments, the logical entanglement may apply conditionally based on the classical value 206 of the quantum property 204. In the example shown in FIG. 2B, the logical entanglements are assigned to a subset of available versions (viz. 1.0.0, 1.0.0, and 1.2.4), and not all versions of the first software package 252-1. In such examples, the logical entanglements are applicable to those versions of the first software package 252-1 that are older than version 1.2.5.

Each possible classical value 206 of the quantum properties 206 may impose further “transitive” logical entanglements. For example, the second package 252-2 may be further dependent on a third package (not shown). In such examples, the third package may impose further constraints (representing compatibilities between the versions) on the possible versions for the first and the second software packages (252-1, 252-2).

In the meta-quantum mechanical paradigm, the quantum properties 204 may be in a superposition of all combination of classical values 206 or permutations in the state space. The quantum properties 204 may be in the state of superposition until the particles 202 are collapsed during unification. Collapsing the particles 202 may yield at least one permutation of the classical values 206 that is consistent with the logical entanglements associated with (or assigned to) each of the quantum properties 204, for a given application/use case. The meta-quantum mechanical paradigm differs from existing physical quantum mechanical systems or quantum computing systems where quantum states/properties of a particle 202 in superposition are represented using quantum wave equations/functions (which may be derived from Schrodinger's equations). Unitary operations (which may be reversible) may be applied to modify states of the particle, and also to determine probabilities of the particle being in each of its possible classical states. The probabilities are computed by taking the inner product of the conjugate transpose of the basis vector of the measurable property with the quantum state vector in Hilbert space, denoted by the bra-ket notation [symbol] x|ψ [symbol] . The actual collapse of a physical quantum property to a classical value through measurement may be a probabilistic outcome based on the probabilities computed from the known quantum state. Thus, there are three aspects of physical quantum mechanical systems that are seen to be conceptually useful to understanding the underlying problem that the meta-quantum mechanical approach solves: particles 202 have properties that exist in a state of superposition, the properties of particles can entangle with each other and statistically correlate, and the superposition of possible particle property values collapse to become “real” classical systems.

In contrast, the particles 202 in the meta-quantum mechanical paradigm remain in state of superposition of the classical values 206 in the state space until a corresponding set of logic kernels (as described subsequently) evaluates/collapses the particles 202 into specific classical values from the state space that are consistent with the entanglements associated with the set of logic kernels. In the meta-quantum mechanical paradigm, the state space representing the superposition of values that the particles 202 may be modified, and eventually evaluated through application of ‘logical operators’ and/or ‘constraints.’ Entanglements between different particles 202 may also be defined using logical operators or constraints. Logical operators, such as Â, are applied to the (quantum state) as a product Â|ψ [symbol] to convey that they operate on the function. Bra-ket notation is used to indicate the evaluation of a specific property of a critically constrained quantum logical system, such as [symbol] x| [symbol] corresponding to the measurement of a quantum property 204 with respect to a basis state for a physical quantum mechanical system, however this should not be confused with the concept of an inner product in Hilbert space used in physical quantum mechanics. The symbol φ or ket notation |φ [symbol] , as used subsequently in the present disclosure, are used to refer to a specific quantum property or sub-system of a composite quantum system Ψ′/particles 202. The use of ψ or φ refers to the quantum system/particle 202, and the use of the ket notations |ψ [symbol] and |φ [symbol] refers to the quantum state of the particle 202. A logical permutation associated with the particle 202 or meta-quantum logical system is denoted as σ in the present disclosure. Further, the particles 202 may be independently developed, and any dependencies or relationship between properties of the same or different artifacts may be represented by assigning entanglements to corresponding quantum properties 204, thereby allowing the particles 202 to be composable, modular, and self-orchestrating during unification.

Each set of the logical entanglements may be postulated logical states |ψ [symbol] in a set of logical states Ψ′, which represents the superposition of logical states of a (quantum) ensemble of logically entangled particles 202. The quantum ensemble refers to one or more particles 202 having logical entanglements therebetween, where the particles 202 may be associated with the same or different artifacts. Each logical state |ψ [symbol] may also be referred to as a logical permutation, or “permutation”. Each permutation/logical state |ψ [symbol] (derived from the set of corresponding logical entanglements) in the set of logical states Ψ′ in superposition may be defined using a set of logical entanglements that produce either a single “critically constrained” solution (i.e., a single permutation as a solution), or an inconsistent or invalid configuration on collapse, where no postulated permutation satisfies all entanglements. In embodiments where the quantum ensemble yields more than one permutation as a solution when collapsed (i.e. the system or solution is under-constrained), additional logical entanglements may be added to reduce the solution space to a critically constrained solution. In some embodiments, a permutation set or quantum state Ψ′ representing under-constrained sets of logical entanglements may not be allowed to exist, and instead may be converted to a larger set of critically constrained permutations that map out all possibilities created by the initial under-constrained set of logical entanglements.

Whether a classical value 206 for the quantum property 204 for a given permutation in the state space satisfies the logical entanglement(s) that predicate the quantum property 204 may be determined by one or more logic kernels associated with each quantum property 204, which may be developed independently as aspects of the quantum ensembles. The logic kernel may include the predicate of a set of first-order predicate logical entanglements. The implementation of the logic kernels and the allowed predicate logical entanglements may be programmable and application-specific. In meta-quantum mechanical systems/quantum ensembles, the postulation of a quantum property 204 includes its basis states, which may be either a set of discrete states or a continuous region of states, and the corresponding logic kernel. The logic kernel may represent the quantum property 204 of the quantum ensemble which is to be solved/collapsed. As stated, the quantum property 204 represents “aspects” of the artifact, which may be developed independently of other aspects of the same or different artifacts, although some of the aspects may be directly logically entangled. Those entanglements may be considered transitive entanglements.

The unification engine 124 may include the logic kernel. In some embodiments, the logic kernels may include a unification oracle (among other oracles) which may be used to determine/evaluate whether the classical values 206 of the quantum properties 204 satisfy the logical entanglements that predicate the quantum properties 204. When the classical values 206 of the quantum property 204 have a rank or ordinality, the logic kernel may provide an optimal oracle, which determines which of all classical values 206 of the quantum property 204 are the “best” valid value in the context of a set of entanglements. The unification oracle and optimal oracle are core elements of the logic kernel which the system 110 uses for arbitrary applications thereof. The system 110 may provide the entanglements that predicate a given quantum property 204 and use the result provided by oracle of the associated logical kernel to evaluate whether each classical value 206 of the quantum property 204 is consistent with the entanglements, and which value is best/highest, if the property values are ranked/ordinal. Logic kernels and corresponding unification oracles may be an extensible aspect of the system 100, enabling the system 110 to be easily adapted to new ecosystems, applications and use cases, with inclusion of new quantum properties 204. The logic kernels may be predefined and reused by the developers 102 while creating new particles 202. The logic kernels may be subsequently used during unification to determine if a specific classical value 206 is consistent with the entanglements associated with the corresponding particle 202.

Both anterior and transitive requirements may result in the creation of new quantum mechanical properties 204 that exist in conditional superposition, with corresponding expansion of the state space representing the possible classical values 206 of the particles 202. Here, transitive requirements which create new quantum mechanical properties 204 may apply in specific transitive logical permutations or states in superpositions created from preceding logical states, and not all possible states of the particles 202, thereby creating a “directed entanglement” between quantum mechanical properties 202 across topologically related logic states.

Consider an example of quantum properties 204 of the same or different particles 202, corresponding to a qubit property Q₁ having a single quantum bit property which exists in a superposition of basis states |0₁ [symbol] and |1₁ [symbol] , where the ‘1’ in the subscript indicates that basis states are for Q₁'s qubit property. Q₁ may impose a transitive rule that when the Q₁ is in the |1₁ [symbol] state, a second discrete quantum property Q₂ must exist as a transitive requirement, with a superposition of 100 different discrete values and basis states |0₂ [symbol] , |1₂ [symbol] , . . . |99₂ [symbol] , and a constraint is imposed on the possible values of Q₂ as a part of this transitive requirement. For example, the constraint may be “Q₂≥60” as a first-order logical predicate. In such examples, an anterior postulate/entanglement “let there be Q₁” or “qubit (1 must exist” creates an initial state space |0₁ [symbol] and |1₁ [symbol] and corresponding logical permutations |φ [symbol] ₀ and |φ [symbol] ₁. When Q₁ is in the state |0₁ [symbol] , no other state space regions are required, and thus |φ [symbol] ₀ represents a converged permutation (which is also critically constrained). However, for an anterior postulate specifying that Q₁ is in the state |1₁ [symbol] , the phase space is expanded with a cross product of the original phase sub-space and the phase space of Q₂, i.e., represented by set {|0₂ [symbol] , |1₂ [symbol] , . . . |99₂ [symbol] }, with a logical entanglement between the Q₂ property and the |1) 1 basis state for Q₁. In this scenario, the quantum properties of particle Q₁ are also entanglement with quantum properties Q₂, and the configuration space or phase space of the meta-quantum mechanical system/ensemble formed using Q₁ and Q₂. Thus, Q₁ carries additional information beyond its quantum bit property.

In this case, the non-converged permutation σ₁ is expanded to 100 additional permutations o₁,0, o₁,1, . . . o₁,99, corresponding to the classical basis states |1₁, 0₂), |1₁, 1₂), . . . , |1₁,99₂). Given a single anterior postulate “let there be Q₁,” applied to the quantum mechanical ensemble/system with the given embedded logical rules, the result is a quantum state ψ that represents a superposition of a set of 101 classical phase configurations given by {|0₁ [symbol] , |1₁, 0₂ [symbol] , |1₁, 1₂ [symbol] , . . . , |1₁, 99₂ [symbol] }. However, these represented classical property phase superpositions are a result of one first-order predicate logic requirement or “anterior entanglement”, which is in superposition with itself in the quantum state set ψ. The anterior entanglement (that Q₁ is equal to 1) limits to state/phase space to 41 of the phases/states, viz. {|0₁ [symbol] , |1₁, 60₂ [symbol] , |1₁, 61₂ [symbol] , . . . , |1₁, 99₂} and corresponding permutations {o₀, o_{1,60}, o_{1,61}, . . . o_{1,99}}, which are internally consistent (such as due to the transitive entanglement requiring Q₂ to be greater 60 when Q₁ equal to 1.

The quantum state |ψ [symbol] , thus, represents a set of converged logic permutations which each includes a set of logic kernels and applied predicate logical entanglements. As opposed to evaluating to complex number (such as in physical quantum mechanical systems), each logic kernel evaluates against its set of predicate logic entanglements to determine which of the superposed basis states are logically consistent with all entanglements. All logic kernels in the permutations may be evaluated for logical consistency, resulting in a quantum state that may be critically constrained, over-constrained, or under-constrained. If the solution is under-constrained, methods for “incremental collapse” are used to critically constrain the solution, as described subsequently in the present disclosure.

In some embodiments, the particles 202 may be generated using any one of programming languages, scripting languages, natural language texts, and/or domain specific languages, but not limited thereto. Each of such languages may have a set of syntaxes that allow quantum logic to be encoded therein. Further, such languages may be associated with a corresponding compiler configured to convert instructions encoded in the language into processor-executable instructions. In some embodiments, the languages may be designed to allow for declarative programming, where the developers 102, or the users 106, may be able to obtain unified classical values 206 for the quantum properties 204 of the particles 202 based on requirements, thereby not requiring such entities to enlist each step to be executed/performed for unifying the particles 202. The unification engine 124 may be configured to translate the request written in declarative languages into graphs, as shown described subsequently in the present disclosure, for unifying the particles 202. The languages may allow the developers 102 to define the quantum properties 204 using Boolean and/or enumeration type variables, and allow logical entanglements to be specified in the quantum context 208 of the classical values 206 of the quantum properties 204 (such as if/else conditional statements or switch-case statements), but not limited thereto. Once the particles 202 are defined, the system 110 may interpret the definitions of the particles 202 and the logical entanglements assigned thereto, determine the state space, and unify the quantum properties 204 to at least one permutation of the classical values 206.

The particle creation engine 122 may be used to define one or more of the particles 202 to represent, unify and actualize aspects of the artifacts. FIG. 2D illustrates a flowchart of an example method 280 used by the developers 102 to define the particles 202.

At step 282, the method 280 may include defining the particles 202 to represent aspects of the artifacts. The quantum properties 204 of the particles may be used to represent the aspects, and the logical entanglements may be used to represent relationships between different aspects of the same or different artifacts. In some embodiments, the particles 202 may be created either manually by the developers 102, or automatically by the particle creation engine 122 on receiving corresponding instructions from the developer device 104. In embodiments where the particles are created manually, the developers 102 may individually define the quantum properties 204 of the each of the particles 202, such as by using the scripting language on their corresponding developer devices 104. In embodiments where the particles 202 are created automatically, the particle creation engine 122 may be configured to translate/convert aspects of existing artifacts into the quantum properties 204 of the particles 202. For example, the particle creation engine 122, on receiving a request from the developer 102, may search and retrieve metadata associated with predefined software libraries, such as metadata pertaining to number of versions of existing software libraries available publicly and accessible by those skilled in the art, such as by execution of one or more application programming interface (API) calls. In some embodiments, an artificial intelligence (AI) agent/engine may be configured to retrieve and parse the metadata from the internet. Such metadata may be converted into the quantum properties 204 of the particle 202 representing the software library. In some examples, the particle creation engine 122 may be configured to receive sensor data, such as GPS coordinates of source and destination locations, retrieve a plurality of routes/roads between the two locations, and convert/represent the routes/roads using a combination of the logical entanglements and the quantum properties 204 of the particle 202.

At step 284, the method 280 includes assigning one or more policy requirements to the particles 202. The policy requirements may include any one of licensing requirements, payment requirements, and the like. For example, developers 102, or the operators of the platform 105, may impose licensing requirements or payment requirements for actualizing certain particles 202. The particles 202 may be enabled for actualization on satisfaction of the policy requirements. For example, the second software package 252-2 may be actualized by the user device 108, when the user device 108 obtains a verifiable license from the developer 102/developer device 104 of the second software package 252-2. In some embodiments, when it is discovered during unification that the actualization of the particles 202 requires the satisfaction of the policy requirements, the system 110 may indicate such requirements to the user 106. The user device 108 may transmit to the system 110 an electronic proof (such as using automatic identification and data capture (AIDC) means) of satisfying such policy requirements. The system 110 may allow the user 106 to actualize the particles on verifying the electronic proof. Such capabilities may be included in the unification engine 124 or at the platform management engine 126.

At step 286, the method 280 includes transmitting, storing, and/or deploying the particles 202 on a two-sided platform (such as the platform 105) or a computing device (such as the user device 108 or the computing device implementing the system 110) for unification and actualization of the particles 202. The particles 202 may be made available on the platform 105 for the users 106 to select, unify, and actualize the particles 202 based on the requirements.

### Deployment of Particles

Once the particles 202 are developed, the particles 202 may be hosted on the platform 105. The platform 105 may allow the predefined particles 202 to be unified and actualized in the user devices 108. The users 106 may select the particles 202 for installation/actualization in the user device 108 based on their requirements. Since the particles 202 may be independently developed, the platform 105 may allow any combination of the predefined particles 202 to be combined/unified based on the requirements.

To allow the users 106 to select the particles 250, the platform 105 may provide any of a graphical user interface (GUI), an API, a command line interface (CLI), and a hardware interface (such as those having knobs, levers, pedals, keys, slots, buttons, control panel, and the like), but not limited thereto. In some embodiments, the users 106 may deliberately select the particles 202 needed to satisfy their requirements, using the aforementioned interfaces. In other embodiments, the particles 202 may be selected automatically, such as when the artifacts are configured to operate autonomously. In some embodiments, the particles 202 selected for actualization may be for execution/implementation of one or more activities. The activities may represent a set of top-level requirements of an abstract project (requiring installation on multiple software packages) that needs to be fully orchestrated, for example. The activities may not hold specific configuration of devices in which the abstract project is to be actualized in. For example, an activity may require one specific version of a software or driver to be installed, whereas another activity may request a conflicting version.

### Unification

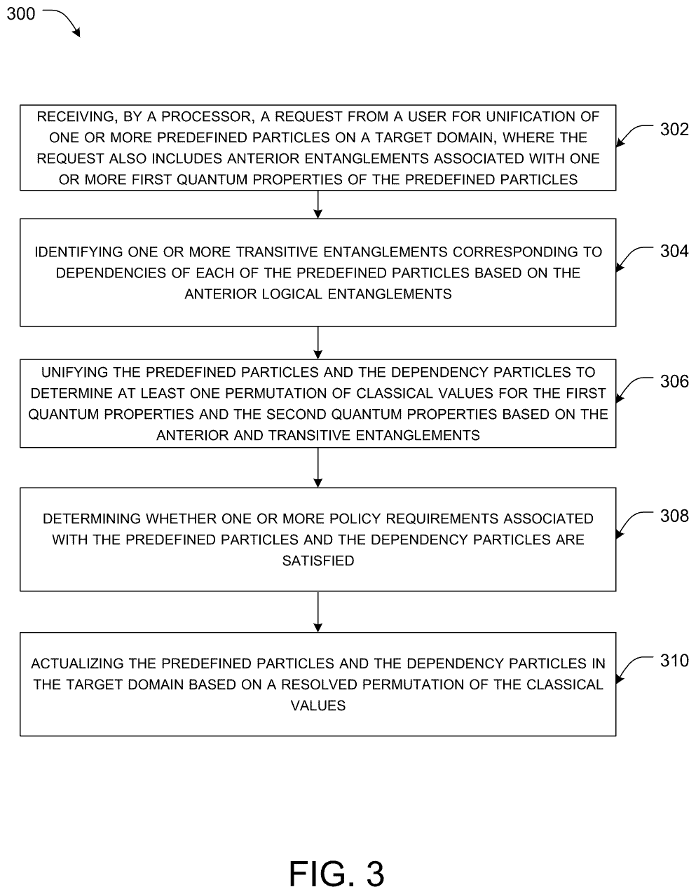

For actualizing the particles 202, the unification engine 124 may be configured to implement a method 300 of FIG. 3, which illustrates a flowchart of an example method for unification of particles corresponding to a high-level user request, according to embodiments of the present disclosure.

In some embodiments, the unification engine 124 may be implemented independently of the user device 108 or the developer device 104, as shown in FIG. 1. In other embodiments, the unification engine 124 may be configured within the user device 108 for actualizing the particles 202 based on a required received from the users 106.

Referring to FIG. 3, the method 300, at step 302, includes receiving a request from the user 106 for unification of one or more of the predefined particles 202. In some embodiments, the request may include the predefined particles 202 required for performing/executing the activities on a target domain. The target domain corresponds to the domain or environment in which the artifacts are to be actualized. For example, when the artifacts correspond to software packages or source code, the domain target may correspond to a shared “file system” target, a shared computer-wide “installed applications” target, or a specific software project instance. In some embodiments, the request may include one or more anterior logical entanglements associated with the one or more first quantum properties of the predefined particles 202.

In some embodiments, the request may be a high-level request written using any of natural language, domain-specific language, scripting languages, programming languages, and the like. In some embodiments, the user may manually produce natural language requests, such as “install pytesseract version 1.2.2 in a python virtual environment”, for unification. In such embodiments, the natural language text may be parsed by the AI engine into a domain specific language or other programming languages that unify the request. In some embodiments, the AI engine may be trained to understand the high-level abstractions represented by particles, and the anterior entanglements that can be used with the system by the AI engine to compose activities, thereby combining the unpredictable yet powerful field of AI with deterministic and manually written and tested ensembles of particles that represent deep domain expertise. In other embodiments, the user device 108 coupled to autonomous artifact may be configured to generate the request, such as based on sensor data collected from sensors in the autonomous vehicle 262. In some examples, the user device 108 may be configured to provide a JavaScript Object Notation (JSON) file of weather data collected by a sensor.

The request may include one or more predefined particles (which are particles 202 predefined by the developers 102 and hosted on the platform 105, and hereafter interchangeably referred to as predefined particles 202). Further, the request may include one or more anterior entanglements specified by the user 106, or the user device 108 based on the implementation. The anterior entanglements may be entanglements that correspond to requirements of the user 106. In some embodiments, the predefined particles 202 in the request may either be the particles 202 predefined and made available by third-party developers 102, or particles 202 that are developed by the user 108 locally. The particles 202 may be developed by the user 108 and used by the same user or team 108, representing a self-serve “platform engineering” approach, where an application may be developed in modular parts with self-orchestrating composability, leveraging opinionated infrastructure to make the implementation of the application more modular, easy to maintain, and easy to reconfigure.

The anterior entanglements may be configured to constrain the state space of the predefined particles 202. For example, when the particle 202 corresponds to the package “pytesseract”, the user 106 may specify the need for a version of pytersseract that is 2.5.2 or newer. In some embodiments, the anterior entanglements may be provided by the user 106. In other embodiments, the anterior entanglements may be provided by autonomous artifacts, such as the autonomous vehicle 262. For example, sensors of the autonomous vehicle 262 may collect environmental data, such as terrain, weather conditions, obstacles near the vehicle 262, and the like, based on which the quantum property 204 associated with maximum allowable speed of the vehicle 262 may be constrained. Specifically, one of the quantum properties 204 of the particle 202 associated with a sensor configured to determine presence or absence of an obstacle using Boolean values, the Boolean value may be provided as an anterior entanglement autonomously by the sensor to the unification engine 124. A “True” value in such example may satisfy application of one of the quantum contexts 208, which may have logical entanglements with another quantum property 204 associated with speed limit/caution indicators for the occupant/autonomous vehicle.

In some embodiments, the unification engine 124, on receiving the request, may be configured to identify the target domain for the predefined particles 202. The target domain for actualizing the particles 202 may be indicated to the unification engine 124 in the request. The target domain may be indicated either explicitly or implicitly. For example, the user 106 may specify that the package pytesseract is to be installed in a specific working folder python virtual environment of version 3.10.*, in a Linux virtual computer. In other examples, when the unification engine 124 is implemented within the user device 108, the unification engine 124 may implicitly identify/detect the file system and/or the installed applications associated with the target domain. The unification engine 124 may conditionally perform unification based on the target domain in the user device 108. In some embodiments, the target domain may also be represented using a quantum property 204 of the particle 202.

The domain target may provide the unification engine 124 with a generic manifest which may be passed to a particle version manifest, which indicates to the unification engine 124 whether that particle version is compatible with the given target domain. Anterior or transitive entanglements may then be evaluated by the unification engine 124 using target and particle version manifests to determine if the entanglement applies. For example, a single particle 202 may be able to be installed in either a C#project or a Python project, providing corresponding assemblies for both scenarios, however, that particle 202 may have a dependency entanglement that only applies in a Python project, or a specific C#.NET framework version.

Target domains may, by ecosystem, define variables that may be evaluated by particle quantum scripts to apply quantum conditional scripting behavior. For example, if a particle 202 is version 1.0.0 (in a quantum context) and the target domain in context has a variable “DotNetFramework” equal to “DotNet8.0”, then the unification engine 124 may add an additional transitive entanglement. It is understood that both the particle 202, its version property, and the existence of the target domain may be in a state of quantum superposition during collapse of top-level requests.

In some examples, the particles 202 may have one or more of the quantum properties 204 indicative of “versions” of software package artifacts, which form a Cartesian space of different versions that the particle 202 may be actualized to. The particles 202 may also have one or more non-version quantum properties, which may be used in the configuration of the actualization of the particle 202, or quantum conditional entanglements on other quantum properties 204. For example, the particle 202 may correspond to a “Microsoft Visual Studio” software having two version quantum properties: Edition (“Community”, “Professional”, and “Enterprise”) and Version (2013, 2019, 2022, etc.) An activity may specify an entanglement that Visual Studio must be installed, and that the Version must be 2019 or greater/newer but leave the Edition property unentangled/unconstrained. During unification (through incremental collapse as explained subsequently in the present disclosure), the user 106 may be required to select the Edition during the incremental collapse process. In the foregoing example, the Microsoft Visual Studio particle 202 may be designed so that its version aspects are separated into concerns that an entangling package may be concerned with ‘the Version,’ and concerns that the user 106 may only be concerned with ‘which Edition’.

At step 304, the method 300 includes identifying one or more transitive entanglements corresponding to dependencies of each of the predefined particles 202 based on the anterior logical entanglements. The transitive entanglements may correspond to dependencies associated with specific classical values (such as software versions of the corresponding software packages). The transitive entanglements may entangle at least one possible classical value 206 associated with the first quantum properties of the predefined particles 202 to one or more second quantum properties associated with one or more dependency particles. To disambiguate the quantum properties of the predefined particles 202 and the dependency particles, the quantum properties of the predefined particles 202 may be referred to as “first quantum properties” and the quantum properties of the dependency particles may be referred to as “second quantum properties.” In some embodiments, in each transitive entanglement, one or more of the first quantum properties may entangle with exactly one second quantum property.

In some embodiments, the quantum contexts 208 of anterior entanglements may have no references to any specific classical values 206 of quantum properties 204, and hence apply to all permutations. The quantum context 208 of transitive entanglements may reference at least one of the classical values 206 of the quantum property 204. If the classical values 204 of more than one of the quantum properties 206 are referenced, then the entanglement only applies to permutations where all referenced quantum properties 206 match the specified classical value 204.

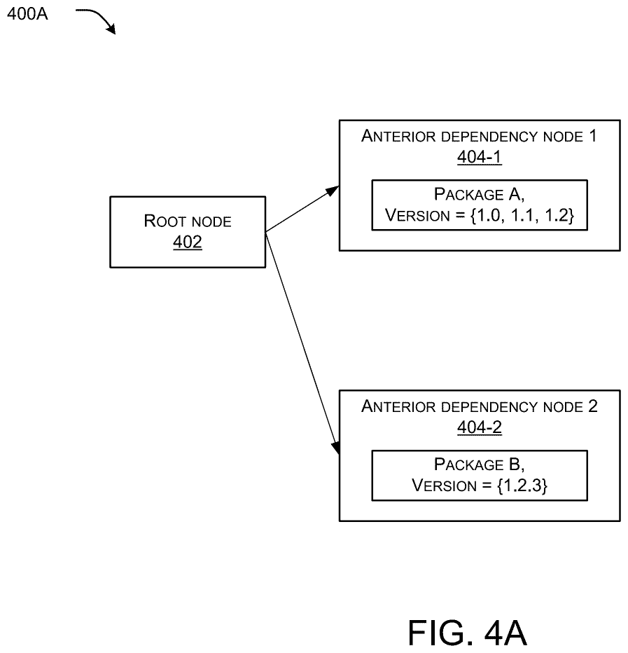

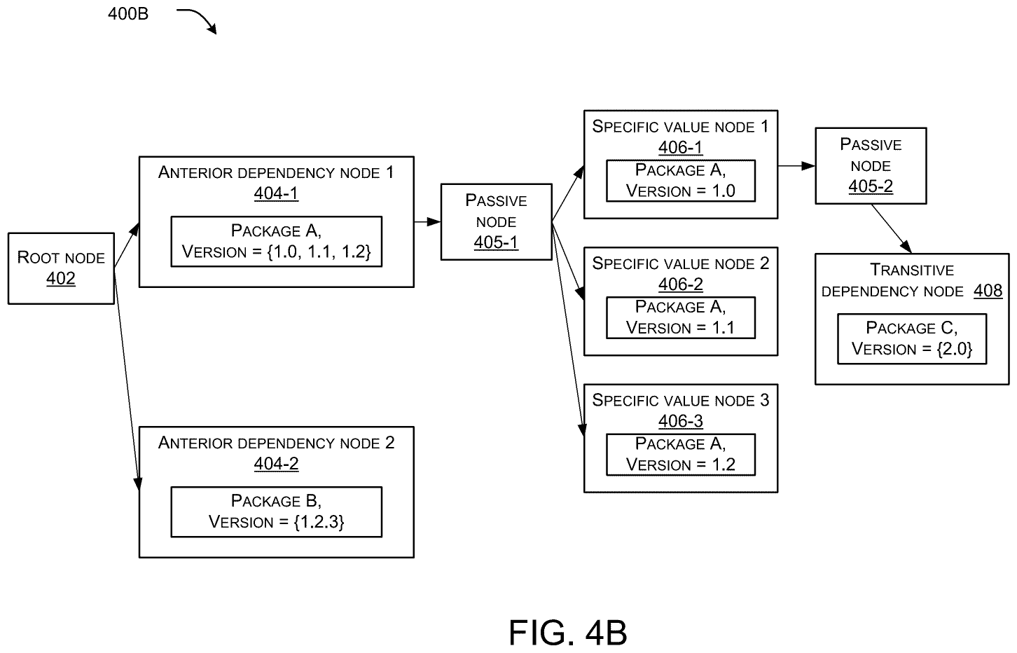

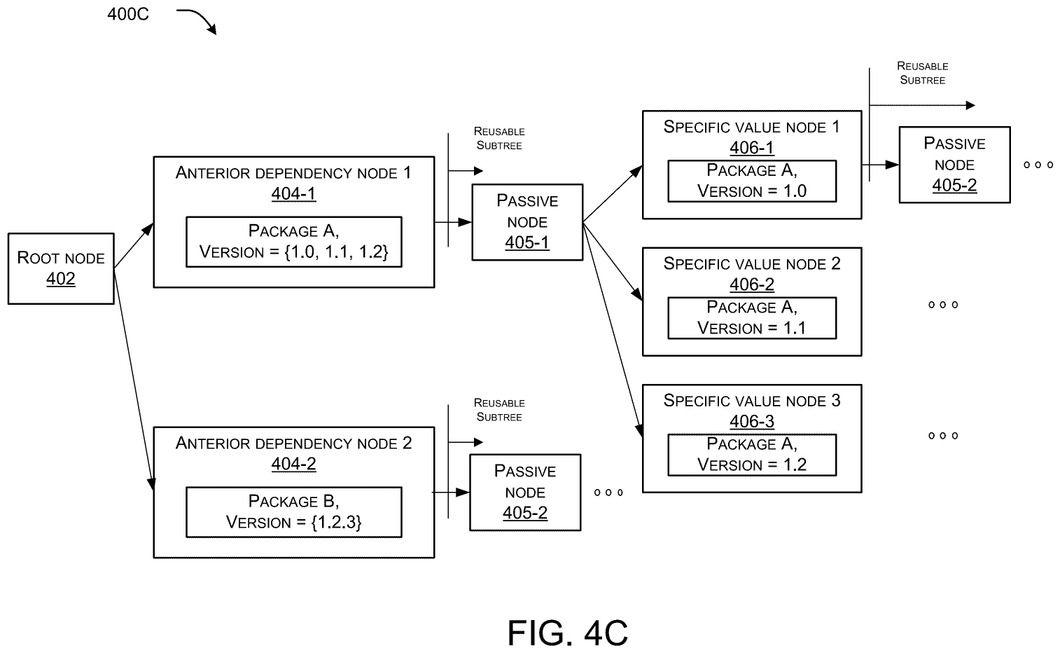

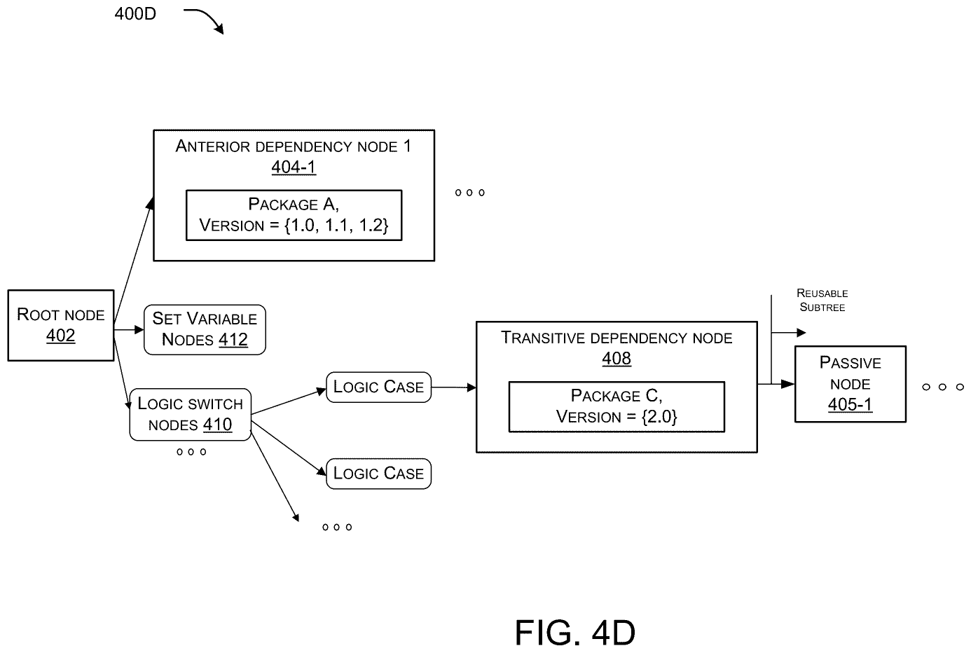

The dependency particles may be particles 202 representing other artifacts on which the predefined particles 202 in the request are dependent on. For example, since pytesseract is a Python wrapper for Tesseract engine, the predefined particle 202 representing the pytesseract package may be dependent on the dependency particle representing the Tesseract engine. More specifically, a subset of versions of pytesseract may be dependent on a corresponding version of Tesseract engine. Further, the Tesseract engine dependency particle may itself be dependent on the Python interpreter being installed. The dependency may be represented using the transitive entanglements. To identify all transitive entanglements required for unification, the unification engine 124 may be configured to generate a unification requirement tree, such as tree 400A-400C described with reference to FIGS. 4A to 4C subsequently in the present disclosure.

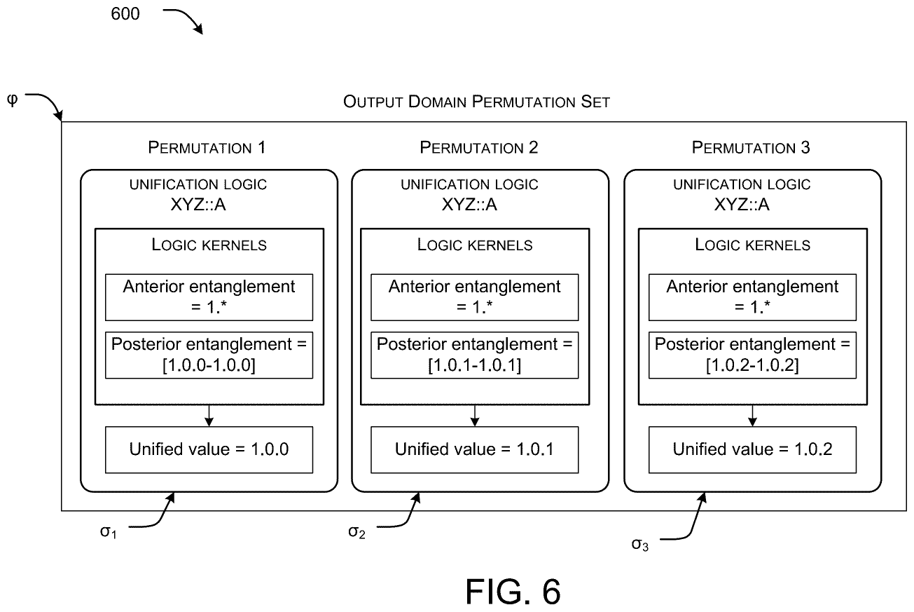

At step 306, the method 300 includes unifying the anterior entanglements and transitive entanglements to determine at least one permutation of classical values for the first quantum properties and the second quantum properties. The classical values 206 may be determined such that the permutation of classical values is consistent/compatible with the anterior and the transitive entanglements identified in step 304. The unification engine 124 may be configured to determine the permutations using techniques described subsequently in reference to FIGS. 6 to 8C. Given the number of permutations arising from the combination of possible classical values 206 of the quantum properties 204 associated with one or more of the particles 202 may have exploding state space (with at least polynomial complexity) and cannot be performed manually (in real time or otherwise), the unification engine 124 may be configured to implement methods that are computationally efficient and memory efficient to identify unifying permutations in real time or near-real time.

At step 308, the method 300 includes determining whether one or more policy requirements associated with the predefined particles 202 and the dependency particles are satisfied. If the policy requirements are not satisfied, such policy requirements are reported to the users 106, which may require the users 106 to, among other things, obtain licenses, approve actualization of particles 202, and the like, but not limited thereto, for satisfying the policy requirements. The means for determining and satisfying the policy requirements are described subsequently in the present disclosure.

At step 310, the method 300 includes actualizing the predefined particles 202 and the dependency particles in the target domain based on a resolved permutation of the classical values. The resolved permutation may be the permutation of classical selected for actualizing the predefined particles and the dependency particles. Actualizing may include installing, configuring, manufacturing, executing decisions, transmitting signals, and the like, associated with the particles 202 based on the classical values 206. The mode of actualizing the particles 202 may depend on the type of the corresponding particles 202, as described subsequently in the present disclosure. The actualization of the particles may be an extensible aspect of the system 110 and allows the system 110 to be adapted to new ecosystems and use cases.

### Unification Tree

FIGS. 4A to 4D illustrate example unification requirements trees 400A-400D, according to embodiments of the present disclosure.

In some embodiments, the users 106 may not necessarily be aware of the dependencies (represented by the transitive entanglements) of the particles 202 at the time of framing the request. In some embodiments, the particles 202 may also have deep transitive implications that the user 106 may be reliant on the system 110 to identify dependencies and transitive entanglements, their unification, and actualization. The transitive entanglements may be identified (such as at step 304 of the method 300) recursively for each predefined particle 202 in the request. In some embodiments, for identifying the transitive entanglements associated with the first quantum properties of the predefined particles 202 based on the anterior logical entanglements provided in the request, the system 110 may be configured to generate a unification requirement tree, such as the trees 400A-400D of FIGS. 4A to 4D. The unification requirement tree may represent the anterior logical entanglements using corresponding anterior dependency nodes 404-1 and 404-2 (collectively referred to as anterior dependency nodes 404). The anterior dependency nodes 404 may originate from a root node 402 corresponding to the request. The root node 402 may represent the entire domain of the particles 202 and target domains.

In example shown in FIG. 400A, the anterior dependency node 404-1 may constrain the possible classical values 206 (i.e. available versions) of the particles 202 corresponding to Package A to versions {1.0, 1.1, 1.2}, and the anterior dependency node 404-2 may constrain the available versions of Package B to versions {1.2.3}. The anterior dependency nodes 404 may be recursively expanded to represent each possible classical value 206, and the expansion may be represented using corresponding specific value nodes 406-1 to 406-2 (collectively referred to as specific value nodes 406), as shown in tree 400B of FIG. 4B. In some embodiments, the specific value nodes 406 for each possible classical value 206 may represent a proliferation of permutations of the quantum values 206, with each permutation having a “posterior entanglement” applied thereto, which constrains each proliferated permutation set created for each specific classical value 205 to that specific classical value 206. For example, multiple permutations (forming a permutation set) may be possible for each classical value 206 of one quantum property 204. The posterior entanglements may constrain the permutation set to one permutation for each specific classical value 206, thereby ensuring that each proliferated permutation either collapses to the classical value 206 indicated by the posterior entanglement or be internally inconsistent. In some embodiments, the unification engine 124 may be configured to determine compatibility between the specific value nodes 406 with a specific target domain, when the specific classical value 206 corresponds to a version quantum property 204. When at least one of the particle's quantum versions corresponding to the specific value nodes 406 are compatible, such specific value nodes may be resolved to the specific target node, and entanglements defined by that particle 202 in the context of the compatible classical values 206 must be respected. When none of the particle's quantum version corresponding to the specific value nodes 406 are compatible, such specific value nodes 406 may be resolved to another target domain, which may be a default target domain resolved by the unification engine 124.

The specific value nodes 406 may further be expanded for identifying other transitive entanglements. The transitive entanglements may be represented using transitive dependency nodes 408, which entangle at least one of the possible classical values 206 represented by the specific value nodes 406 with another quantum property (such as the second quantum property) of the dependency particle. For example, the Version 1.0 of Package A may be dependent on Version 2.0 of Package C. The unification engine 124 may be configured to recursively expand both the anterior dependency nodes 404 and the transitive dependency nodes 408, as shown in tree 400C of FIG. 4C. The recursive expansion continues until all dependencies of the predefined particles 202 and the dependency particles are identified.

In some embodiments, the anterior dependency nodes 404 and the transitive dependency nodes 408 (collectively referred to as dependency nodes) may be expanded based on the dependencies of the corresponding particles 202. In some embodiments, the dependencies may be included in metadata associated with the particles 202. In other embodiments, the dependencies may be accessed from a public repository of the particles 202, such as the platform 105.

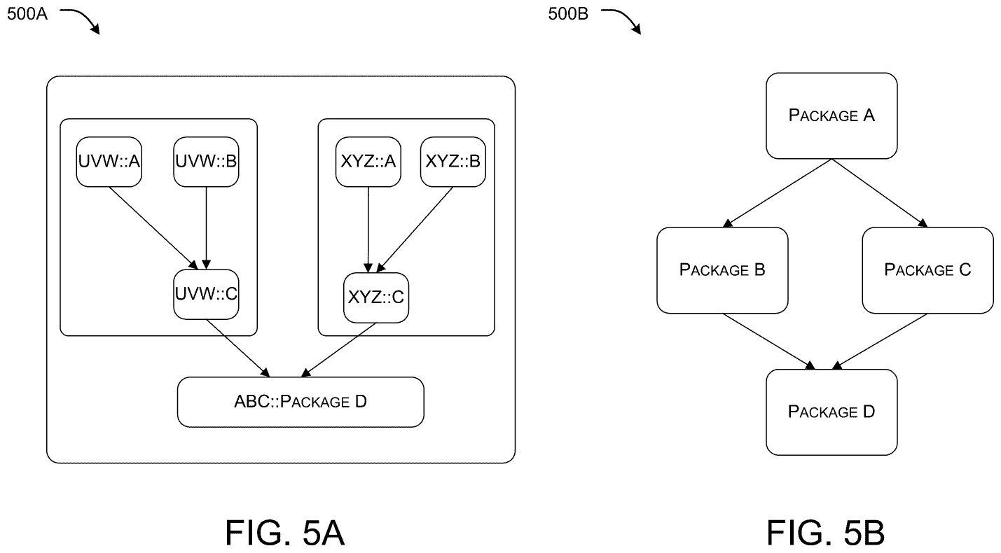

In some embodiments, the connections between the specific value nodes 406 and the dependency nodes may be made using cloneable passive nodes 405-1 to 405-3 (collectively referred to as passive nodes 405). During the recursive expansion, if any of the dependency nodes were in accordance with a previous recursion, the passive nodes 405 may be inserted with a reference to the previous expansion, thereby eliminating the need to recompute/redetermine the dependencies associated therewith and minimizing storage of redundant information in the memory. Such insertion of passive nodes 405 conserves computing resources required for recursive expansion, by reducing redundancy of expanding nodes that were previously expanded. In another embodiment, the passive nodes 405 may also be used when the particles 202 have diamond-shaped dependencies (such as when a first package is dependent on a second and a third package, which are further dependent on a fourth package, as shown in FIG. 5A), or a ‘V’-shaped dependency (such as when a first package is dependence on a second and a third package, as shown in FIG. 5B).

In some embodiments, the dependency nodes may correspond to non-conditional entanglements (such shown in FIGS. 4A to 4C), or conditional entanglements. In some embodiments, the non-conditional entanglements may correspond to anterior entanglements, which apply for all possible permutations in the permutation set (such as permutation set 600 shown in FIG. 6). The dependencies from such entanglements may be represented using dependency nodes that are directly connected to the root node 402. In some embodiments, the conditional entanglements may be entanglements that apply on satisfaction of corresponding quantum context 208. Such entanglements may be represented using logic switch nodes 410 (which may correspond to switch-case logical statements and the associated quantum configuration variable/quantum property 204C), as shown in tree 400D of FIG. 4D. The logic switch nodes 410 may be further connected to logic case nodes, which apply based on the quantum properties 204 being collapsed to specific classical values 204 that correspond to the quantum context 208. Each logic case may be connected to corresponding transitive dependency nodes 408, thereby representing the logical entanglements associated with the corresponding quantum context 208. The conditional entanglements may allow the state space to be constrained to those classical values 206 of the predefined particles 202 that satisfy the conditional statement. The variable may either be provided as part of anterior logical entanglement in the request, or inferred from the transitive entanglement (i.e. based on the specific value node 406). Set variable nodes 412 may be created corresponding to entanglements specified for quantum version variables and quantum configuration variables/quantum property 204, specified in a quantum script which exist in a quantum context 208. The set variable nodes 412 may be functionally similar to anterior dependency nodes 404-1 and transitive dependency nodes 408 in that they both entangle quantum properties 204.

### Dependency Graph

FIGS. 5A and 5B illustrate example dependency graphs 500A and 500B, respectively, generated by the unification engine 124 from the unification requirement trees, according to embodiments of the present disclosure.

The dependency graph (such as dependency graphs 500A and 500B) may be used to represent the dependencies associated with the predefined particles 202 and the dependency particles, based on the entanglements identified in the unification requirement tree (such as trees 400A-400D). In some embodiments, the dependency graphs 500A, 500B may be generated by connecting each child dependency node and with a corresponding parent dependency node using an edge to represent dependency therebetween. The child dependency nodes and the parent dependency nodes are obtained from the unification requirement tree explained above. For example, the transitive dependency nodes 408 may be child dependency nodes and the anterior dependency nodes 404 may be the parent dependency nodes.

Each node shown in the dependency graph 500A represents a package or particle associated with an installation target or logical domain. Each node lists two strings. A prefix string refers to the installation target, project, or logical domain (all equivalent abstractions), and a suffix string refers to the package or particle class (also equivalent abstractions). For example, dependency graph 500A represents dependencies between four packages (or generally particles 202) implemented in 3 different target domains. The packages include Package A, Package B, Package C, and Package D, and the domain targets include UVW, XYZ, and ABC. The dependency graph 500A may efficiently compute a target package's transitive subgraph, which is important for a computational optimization described later. The dependency graph 500A may not be concerned with version-specific relationships. If any version of a Package A depends on any version of a Package C or has any entanglements with Package C, then Package A is said to depend on Package C or express entanglements with Package C. The dependency graph 500A may produce the representation of numerous initial determinations of the self-assembling domain, including particle dependency relationships, particle domain compatibilities, and particle domain resolution where a first particle 202-1 expresses a transitive entanglement on a second particle 202-2 which may not be compatible with the entangling particle's target domain. The unification engine 124 may be configured to resolve the correct target for the second particle.

Each node in the dependency graph 500A may represent an independent aspect of the artifacts, developed independently by the developers 102, which enables effective composable orchestration of the graph 500A. In some embodiments, the dependency graph 500A may be configured to represent the entanglements/dependencies between specific classical values 206 of the first quantum properties to the second quantum properties, such as in the example shown in FIG. 2A. However, the example shown in FIG. 5A hides the entanglements between the specific classical values 206 for the purposes of clarity. While the unification requirement trees (400A-400D) allow the logical entanglements to be represented, the dependency graphs allow the dependencies between predefined particles 202 and the dependency particles to be identified. The unification engine 124 may also be configured to identify and unify diamond-shaped dependencies, as shown in the dependency graph 500B. Subsequent embodiments in the present disclosure describe the ability of the unification engine 124 to resolve such dependency in contrast with existing solutions that use imperative scripting.

In some embodiments, when a specific classical value 206 causes an entanglement on another particle 202 based on the quantum context 208, the entanglement may define the particle type, name, and entanglement logic used to constrain the particle 202. The entanglements may be homogeneous (i.e., an entanglement source and destination both have the same domain/target) or heterogeneous (i.e., the entanglement source can entangle with a particle in a different domain). For example, the dependencies associated with the entanglements may allow the dependency particles to be actualized in the same target domain (such as in the same computing environment), or in different target domains (such as a first package being actualized in a first computing environment and a second package being actualized in a second computing environment, in a distributed computing architecture).

In some embodiments, to resolve the target domains of the particles 202, the unification engine 124 may be configured to determine compatibility between the specific value nodes 406 with the specific target domain. In such embodiments, the particles 202 may include the quantum property 204 corresponding to versions of a software package. In some embodiments, the specific target domain may provide manifests, using which the unification engine 124 may determine compatibility of a version with the target domain. In other embodiments, the target domain may be represented using quantum properties 204 that may be entangled with the predefined particles 202. For example, a target domain corresponding to a C++ project may be generated by the unification engine 124, where the system 110 operates as a build system generator. Some particles 202 being installed into the C++ target may be agnostic to the versions of C++ or compiler is used in the C++ project. Other particles 202 may only build with specific compilers or versions of C++. The version of the particle 202 may simultaneously attempt to entangle with the C++ version and/or check compatibility therewith. Versions that are found to be compatible with the target domain may be actualized.

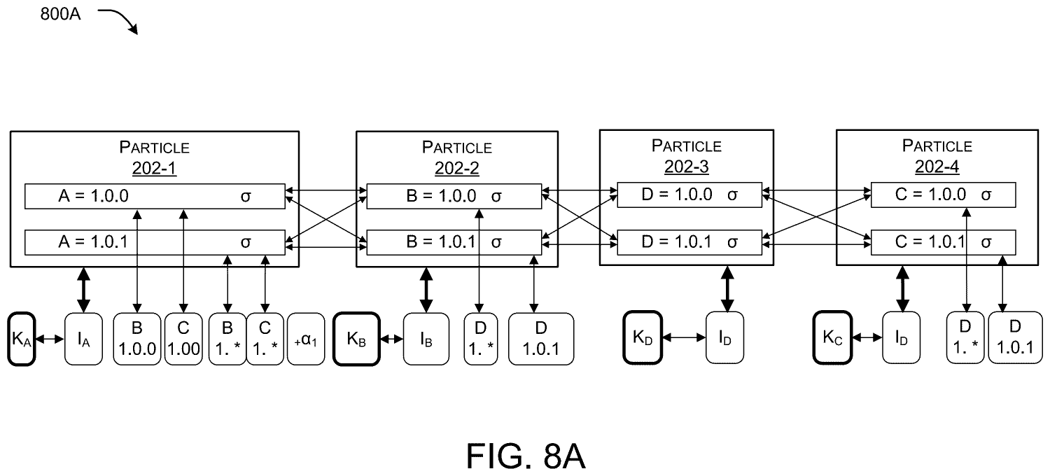

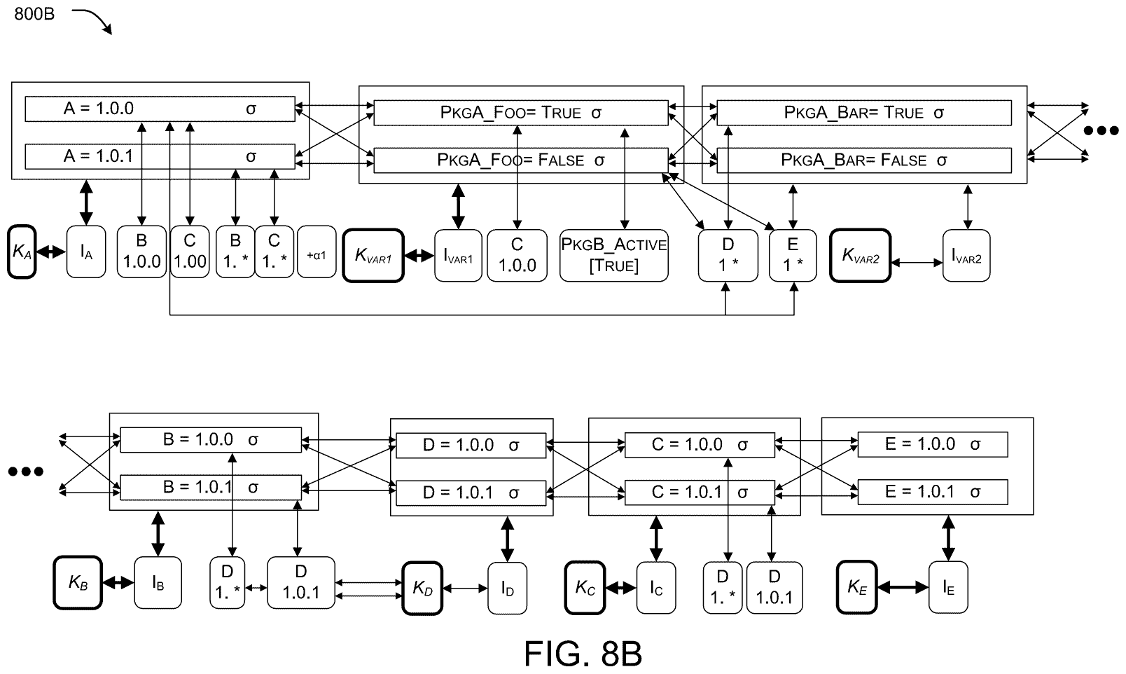

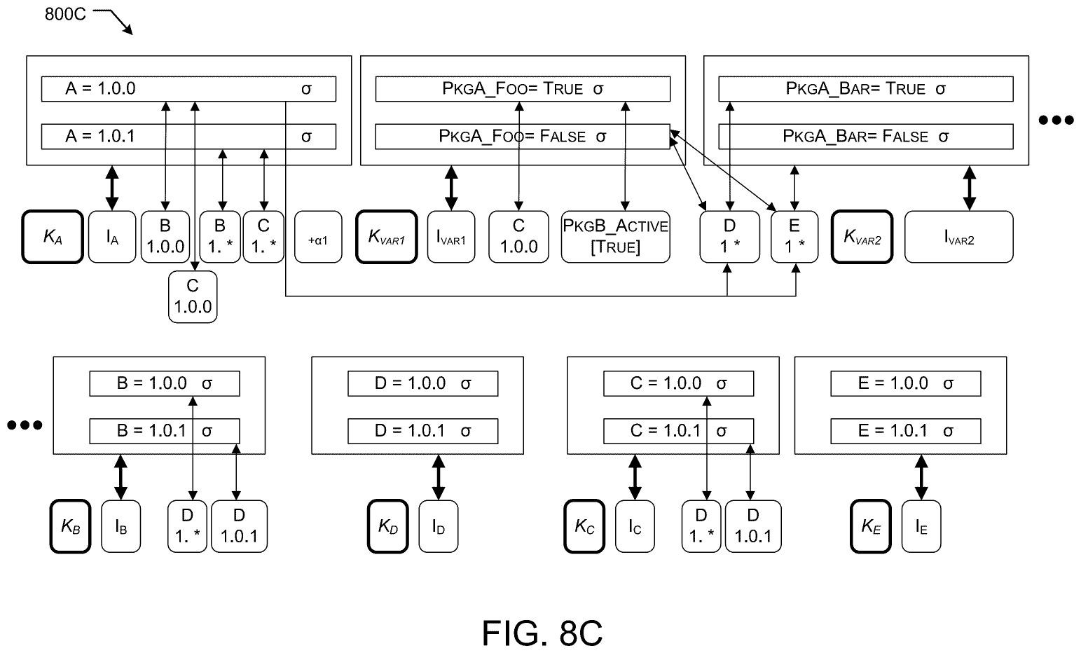

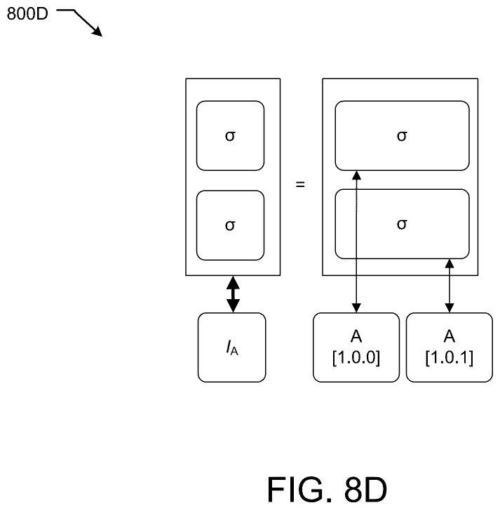

The specific target domain may be indicated by the anterior entanglement nodes 404. When the specific value nodes 406 are compatible with the specific target domain (i.e. when the dependencies are homogenous), the unification engine 124 may resolve the specific value nodes to the specific target node. When the specific value nodes 406 are not compatible with the specific domain, the unification engine 124 may be configured to resolve the specific value nodes 406 to another target domain, such as a default target domain (i.e. when the dependencies are heterogenous). In such embodiments, the unification engine 124 may find the correct target, when the entanglements do not have knowledge of the appropriate target for actualization of the dependency particles. In other embodiments, the unification engine 124 may resolve the compatibility of targets during unification using a particle entanglement map, as shown in FIGS. 8A to 8C.

While the present disclosure describes the construction of trees and graphs for identifying transitive entanglements and dependencies of the predefined particles 202 in the request, it may be appreciated by those skilled in the art that any other representations/data structures may be used to represent the transitive entanglements associated with each possible classical value 206 of the quantum properties 204 after the anterior logical entanglements provided in the request are applied. For example, the transitive entanglements may also be represented using adjacency lists, adjacency matrices, symbolic representation, sets, and any other data structure suitably adapted to allow dependencies to be identified recursively.

Once the transitive dependencies of the predefined particles 202 are identified, the unification engine 124 may be configured to determine a combination/permutation of classical values 206 for each of the quantum properties 204. The permutation may be determined such that the classical values 206 are consistent with the anterior logical entanglements and the transitive entanglements. In some embodiments, the unification engine 124 may be configured to determine all possible permutations (also referred to as permutation proliferation) for the quantum properties 204 of the predefined particles 202 and the dependency particles. In such embodiments, the unification engine 124 may filter/prune the permutations obtained during permutation proliferation and determine at least one permutation the set of all possible permutations that satisfy the anterior entanglements and the transitive entanglements. In other embodiments, the unification engine 124 may be configured to generate a particle entanglement map and incrementally collapse the predefined particles 202 to a specific classical value 206, as described subsequently in the present disclosure.

In the foregoing discussion, the system 110 computes the transitive unification requirement/entanglement tree to map out all requirements and entanglements, and once the entanglement tree converges, the entanglement tree is reduced to the domain entanglement graph. Thereafter, the system 110 identifies the different permutations using a technique call permutation proliferation, as described below.

### Permutation Proliferation

FIG. 6 illustrates example permutations 600 of classical values of the particles having anterior logical entanglements, according to embodiments of the present disclosure.

Under permutation proliferation, the unification engine 124 may be configured to generate a set of permutations of possible classical values 206 for all quantum properties 204 (such as for both the first quantum properties and the second quantum properties). The set of permutations may be the cartesian or tensor products of each of the possible classical values 206 of the quantum properties 204 based on a plurality of entanglements of the predefined particles 202 identified in the dependency graph. The unification engine 124 may prune the set of permutations that may be inconsistent with the anterior logical entanglements and the transitive entanglements. If the pruning process filters the set of permutations to only one permutation that satisfies the anterior and transitive entanglements, the domain may be said to be critically constrained. In such embodiments, the permutation may be used for actualizing the particles 202. In other embodiments where after pruning, multiple permutations satisfy the anterior and transitive entanglements, the unification engine 124 may (incrementally) collapse the predefined particles 202 and the dependency particles to critically constrain the particles 202, as described subsequently in the present disclosure.

The unification engine 124 may initiate permutation proliferation by identifying all possible ways in which the domain of the particles 202 may be unified, beginning with a domain that is either empty or previously unified, as part of the root requirement. The attachment of a root requirement (or script) to the domain is called a “domain unit of work,” and represents an attempt to transition the domain from one unified state to another.

The domain may be initiated with 1 or more ways, or “permutations,” that satisfy all previous root requirements, and may result in 0, 1, or more permutations that satisfy all root requirements with the addition of the next root requirement. If there are 0 permutations that result, then this means that the domain has failed to unify with the introduction of the new dependency: the domain is “over-constrained”. If the result is exactly one permutation, then the domain is “critically constrained”. If the result is more than one permutation, then the domain is “under-constrained”. When the domain is under-constrained, the unification engine 124 may be configured to identify the “best” permutation off the internally consistent set of permutations through incremental finalization/collapse, as described subsequently in the present disclosure.

To generate the set of permutations, the unification engine 124 may be configured to generate a list of all possible combination of classical values 206 for the quantum properties 204 of the predefined particles 202 and the dependency particles. Each permutation may be represented using the notation σₙ. The permutations on may be determined by computing the sets of all possible classical values 206 of each quantum property 204. The permutations may be determined by recursively computing cartesian products of each new dependency identified in the dependency graph.

In an example provided in FIG. 6, a set of permutations 600 may be generated from a request for unification of the predefined particles 202 indicative of Package A, and an anterior logical entanglement that allows the Package A to have any version 1.* to be installed into the target domain Target XYZ. Package A may have three possible classical values 206 (or versions) for the corresponding quantum property 204, viz. 1.0.0, 1.0.1, and 1.0.2. The unification engine 124 may generate the set 600 having three permutations, viz. permutation σ₁ where the version is 1.0.0, permutation σ₂ where the version is 1.0.1, and permutation 03 where the version is 1.0.2. Each of the permutations may be generated by conditionally adding a corresponding posterior entanglement. The posterior entanglement may be entanglements that force the quantum property 204 to either unify to the specific value for that permutation, or invalidate the permutation.

In some embodiments, each of the permutations may be associated with a unique outcome or possible state of the quantum ensemble. Each permutation may hold one or more logic kernels corresponding to all quantum properties 204 of the predefined particles 202 and the dependency particles that are postulated to exist for that state. Each logic kernel may contain a posterior entanglement that constrains the outcome of that quantum property 204 to a specific classical value 206 that is determined during permutation proliferation to cover all possible classical values 206 of the quantum ensemble. In some embodiments, each permutation in the permutation set may have a “unification logic” instance for each target package/particle 202 in the domain, as well as an equivalent/corresponding logic kernel for any quantum properties 204 that have been defined. Each unification logic for each target package or other programmatic quantum variable logic kernel may hold all top-level and transitive requirements or entanglements imposed on the target package's unification logic or variable's logic kernel, as well as posterior dependency requirements added by the unification engine 124 during unification. Since the logic kernels may have exactly one posterior entanglement, the logic kernels may either unify to the specific classical value 206 (or version of the package in the foregoing example) of the posterior entanglement, or may be invalid due to a conflict/inconsistency between the posterior entanglement and the non-posterior entanglements (as described subsequently). A permutation is invalid if any one of its logic kernels is invalid. The quantum ensemble may be over-constrained if no permutations are valid after permutation proliferation. The quantum ensemble may be critically constrained if exactly one permutation is valid, and under-constrained if more than one permutation of the system is valid.

Returning to example in FIG. 6, the unification engine 124 may be configured to compute the permutation set that holds all possible permutations. Each permutation has one unification logic kernel instance for the XYZ::A target package, where each unification logic in each permutation holds two dependencies (viz., an anterior dependency and a posterior dependency). The anterior dependency is given by “1.* “, indicating that the package may be of any minor version of the major version ‘1’. The posterior dependency may be a requirement for a specific version of Package A, for example [1.0.0-1.0.0] means only version 1.0.0 of Package A is allowed. Similarly, other posterior dependencies may be introduced to generate other permutations, such as [1.0.1-1.0.1] to allow only version 1.0.1 of Package A, and [1.0.2-1.0.2] to allow only version 1.0.2 of Package A. The posterior dependency may be applied by the unification engine 124 to create permutations (denoted by σ) that are forced to either unify to specific versions of Package A “after the fact”, i.e. “posterior”, or to create a unification conflict which will destroy the permutation. While FIG. 6 shows each permutation holding one logic kernel, it may be appreciated that each permutation may include multiple logic kernels, based on the requirement.

Once the permutations are enumerated, the unification engine 124 may be configured to filter non-unified permutations. The version notation “1.*” means “take the latest version that has a major version of 1,” thus specifying that the logic kernel must use a value rank order. Evaluation/filtering of a permutation may involve evaluating the unification oracle for all first-order predicate logic kernels held in the permutation. If all logic kernels are unified, the permutation is unified. If any logic kernel is not unified, the permutation is non-unified. Whether the logic kernels are unified may be determined by the unification oracle of the unification logic associated with the logic kernel. The unification oracle may be configured to evaluate each version (associated with the permutation/logic kernel) against all dependencies in the unification logic. If the version fails to satisfy any dependency requirement captured in the unification logic, whether anterior or posterior, the version is discarded, or determined to be ‘not unified’.

The unification logic may be configured to the ‘best’ version from all compatible and filtered versions, or null if no version is satisfied. The “unified value” shown for each permutation σ in FIG. 6 represents unification logic's evaluation with posterior dependencies enabled. Permutation 1 unifies to 1.0.0, as only 1.0.0 satisfies the version-specific posterior dependency [1.0.0-1.0.0], and so on. The 1.* anterior dependency does not further filter any versions. Similarly, Permutation 2 unifies to 1.0.1, and Permutation 2 unifies to 1.0.2.

Although both physical quantum mechanical systems and meta-quantum mechanical systems are eventually reduced to specific classical values, the expansion of the initial permutation set by taking the tensor product of the initial set with a vector of posterior version-specific dependencies corresponding to each classical value (version), and then applying the anterior entanglements to obtain the resultant matrix, produces a matrix of logic kernels that are unique in the Euclidean phase space or configuration space of the quantum assemble/meta-quantum mechanical system. The determination of the permutation set is differentiated from physical quantum mechanical systems, where the probabilities associated with a particular classical property is computed as the inner product of the complex conjugate transpose of the basis vector of the classical property to be measured and the quantum state vector to separate and reduce the information held by the quantum state to the information about a specific classical property.

Once the set of permutations are identified, the unification engine 124 may be configured to select/filter the (“best”) permutation to unify, using rank ordered logic kernels. In under-constrained scenarios, the best permutation may be selected by disabling the posterior dependencies of the unification logic, re-evaluating the unification logic, and determining if the result changes. In the foregoing example in FIG. 6, by disabling posterior dependencies, the results of Permutations 1 and 2 are changed, whereas the result of Permutation 3 is not changed, thereby indicating that the unified value of Permutation 3 is the “best” result. The unification engine 124 may be provided with predetermined rules from the developers 102, selection of permutation from the user 106, or heuristic or deductive methods, based on which the “best” permutation may be determined. Here, the “best” version may correspond to the latest version of Package A, which is the unified value 1.0.2 of Permutation 3.

Thus, in this simple example, the under-constrained permutation obtained for domain XYZ::A::1.* is reduced to a single permutation, Permutation 3, by the unification engine 124. The unification engine resolves to the “best” permutation based on knowledge embedded in the rules therewithin. In foregoing description, the determination of “best” permutations from permutations sets may be generalized to cases having multiple anterior entanglements. In some embodiments, the non-finalized permutations may be retained (such as by storing to the memory 114), to leverage the additional degrees of freedom when considering subsequent additional anterior entanglements. In such embodiments, the permutations may be filtered using incremental finalization/collapse. The operations performed by the unification engine 124 for determination of the entire permutation set is formalized below.

The unification engine 124 may be configured to implement a function that takes an input permutation set (which represents all possible domain permutations given the requirements before the new dependency requirement are applied) and root requirements as input to generate an output permutation set. The output permutation set may be represented as:

$${φ}_{OUT} = {∀}_{D} ( {φ}_{IN} , α )$$

where,
φₒᵤₜ is the output permutation set,
∀_{D} represents to anterior entanglement operator associated with dependency D,
φ_{IN} represents to the input permutation, and
α represents the root requirement/anterior entanglement.

In the foregoing example, α=XYZ::A::1.* (a dependency requirement for version 1.* of Package A to be installed in installation target XYZ). Further, the operator ∀ and entanglement argument α are associated with the dependency requirement expression XYZ::A::1.*. The α term is the dependency/entanglement, used in unification logic, and the ∀_{D} term is the dependency expansion operator function that operates on the input permutation set using the dependency/entanglement α.

To re-formalize, the unification engine 124 receives a default/input permutation set which consists of only one permutation with no unification logic elements (an empty or null permutation). The operator for V is computed and then the operator ∀_{D} is evaluated with inputs PIN, and dependency/entanglement α=XYZ::A::1.*.

The example illustrated in FIG. 6 (and the equations provided above) assumes that each version of the Package A does not have further transitive entanglements with other packages. Further, since the quantum properties 204 of the particles 202 remain in a set of superposition until they are collapsed, the set of all permutations may be represented as the logical states of the particles 202.

To include (and generalize the function to) transitive dependencies, the anterior dependency function ∀_{D} performs “separable expansion” by first splitting the input permutation set φ_{IN} into two different sets, viz., a first permutation subset φ_{IN,α∈}_{_{φIN}} with permutations that all have a reference to α's target package, and a second permutation subset φ_{IN,α∉}_{_{φIN}} with permutations that do not have a reference to a's target package. The first and the second permutation subsets may be determined by iterating through the input permutation set, and if the permutation references the target package/domain associated with the dependency α, that permutation is added to the first permutation subset. Otherwise, the permutation is added to the second permutation subset.

Since the permutations in the first permutation subset φ_{IN,α∈}_{_{φIN}} already reference the target package/domain associated with dependency α, new permutation set of possibilities is determined by a scalar addition of a to the first permutation φ_{IN,α∈}_{_{φIN}}, given by:

$${∀}_{D , α ∈ {P}_{IN}} ( {φ}_{IN , α ∈ {φ}_{IN}} , α ) = {φ}_{IN , α ∈ {φ}_{IN}} + α$$

Scalar addition of a dependency (or entanglement) α to the first permutation set φ_{IN,α∈}_{_{φIN}} involves adding the dependency/entanglement to the unification logic kernel with a target package that corresponds to the dependency's target package/domain, for all permutations in the set. By definition, all permutations in the set φ_{IN,α∈}_{_{φIN}} have a unification logic kernel instance for a's target package. The unification logic may not be added unless all its transitive requirements were already added. Scalar addition of the dependency α to φ_{IN,α∈}_{_{φIN}} then includes adding the dependency/entanglement of a to the corresponding unification logic for a's target package/domain in all permutations.

The second permutation subset φ_{IN,α∉}_{_{φIN}} represents all possibilities/permutations of the domain's state that do not locally reference a's target package. However, existing packages in the second permutation subset may be referenced dependency α's transitive dependencies. For example, if package A depends on package B, and XYZ::B is already referenced in the existing permutation set, then the function operator ∀_{D} for dependencies referencing XYZ::A may internally support unification mechanics in the context of XYZ::B. To compute the output permutation set, a permutation expansion operator or a permutation proliferation operator (represented as ∈_{α}) may be used as shown below:

$${∀}_{D} ( {φ}_{IN , α ∉ φ IN} , α ) = {∈}_{α} ( {φ}_{IN , α ∉ φ IN} + α )$$

The expansion operator Ex may be used by the unification engine 124 to recursively expand a copy of the second permutation subset φ_{IN,α∉}_{_{φIN}} against all local and transitive requirements/entanglements indicated by this version of α's package for each of ‘N’ versions of α's package (or equivalently, for both values of Boolean quantum properties, or for each ‘N’ possible classical values 206 of enumeration quantum properties 204). The resultant set may be called “Version-Specific Post-Transitive Permutation Set” (“VSPTPS”), or generally as “Post-Transitive Permutation Set”. For a package with N versions, N version-specific post-transitive permutation sets may be generated. The computation of the version-specific post-transitive permutation set, and an optimized variant thereof, is described subsequently in the present disclosure.

All permutations in the current context include the dependency/entanglement α, so the a entanglement is scalarly added to a copy of the second permutation subset φ_{IN,α∉}_{_{φIN}}. The expansion operator may be used for one possible version/classical value 206 (defined by α::v) associated with the permutations in the second permutation subset φ_{IN,α∉}_{_{φIN}}, where the package version metadata may specify anterior requirements of the package version. In some embodiments, the anterior requirements include additional package dependencies, variable settings, and variable logic switching.

In some embodiments, the version α::v may have further ‘D’ dependencies of its own. For the first dependency d₀ of α::v, a new permutation set φⱼ₌₀ may be determined using the same top-level operator ∀_{D}, passing the input permutation set φ_{IN,α∉}_{_{φIN}} and dependency, d₀:

$${φ}_{j = 0} = {∀}_{D} ( {φ}_{IN , α ∉ {φ}_{IN}} , {d}_{0} )$$

Then, for j=1 to D-1, the next permutation set φⱼ is computed using the next dependency dⱼ of α::v, using the output of the previous recursive expansion Pi-1 of the previous dependency dⱼ:

$${φ}_{j} = {∀}_{D} ( {φ}_{j - 1 ,} {d}_{j} )$$

This process is called “permutation sweeping”, the unification engine 124 recursively sweeps through all anterior dependencies specified by a specific version of the package, sweeping up additional permutations as it collects new domain requirements. If a package version α::v does not have any other dependencies (or other transitive effects), φ_{IN,α∉}_{_{φIN}} is taken as the result of this step without any changes. The permutation sweeping process may be iterated for all dependencies, with the final dependency being represented as (assuming the version α::v has D dependencies):

$${φ}_{D - 1} = {∀}_{D} ( {φ}_{D - 2} , {d}_{D - 1} )$$

After permutation sweeping is performed for the anterior dependencies that the package version specifies, variable setting anterior requirements specified by the package version metadata may be applied. For this, an anterior variable setting operator ∀_{VSET} may be defined (where ∀ indicates “anterior” and ν_{SET} indicates “variable set”). The anterior variable setting operator may take the input permutation set and a variable setting requirement ν_{SET} as arguments/inputs, and may return the output permutation set, represented as:

$${φ}_{OUT} = {∀}_{V S E T} ( {φ}_{IN} , {v}_{S E T} )$$

In some embodiments, the variable set ν_{SET} may specify a variable type, a variable name, a variable value, and a specification indicating which target package context the setting is made from. The ∀_{VSET} operator modify the permutation set by performing a scalar addition of the variable setting requirement/entanglement ν_{SET} to all permutations in the set, rather than expanding the permutation set. The entanglement associated with the variable set operators may be applied to the logic kernel associated with the corresponding quantum variable definition. The variable setting entanglement may have an entanglement source, and an entanglement target associated therewith, which may be located/identified from the transitive unification tree requirement. For instance, the entanglement target may be located by finding the set variable node 412 in the transitive unification tree (e.g., 400D), and searching for any logic switch node 410 that references the same variable name.

Each permutation may store a list of (ν_{SET}) specifications, including the located entanglement target(s), computed from the transitive unification tree. The ∀_{VSET} operator may add the specifications to all permutations in the set. Since there is no permutation expansion during determination of variable set specification, no separable permutation expansion may be associated with the anterior variable setting operator. Permutation expansion/proliferation is not required for variable set identification, because the specification of the evaluation of a quantum variable, which creates a corresponding logic kernel, forces the proliferation of permutations through the tensor product of the new logic kernel with the existing permutation set.

As with anterior dependencies, the ∀_{VSET} operator is called for each of ‘V’ variable setting requirements specified by the target package version (or classical value 206), in sequence, taking the output permutation set result from anterior dependency permutation sweeping and feeding the output permutation set result into the first ∀_{VSET} operator recursively until permutation sweeping is completed for all variable setting requirements, as formalized below:

$${φ}_{v = V - 1} = {∀}_{V S E T} ( {φ}_{v = V - 2} , {v}_{S E T V - 1} )$$

This results in all permutations in the incoming permutation set having all variable setting requirements/entanglements specified by this package version added to their list of variable setting requirements/entanglements.

After permutation sweeping is performed for anterior variable setting requirements that the package version specifies, anterior variable evaluating requirements specified by the package version metadata may be applied by the unification engine 124. For this, an anterior variable evaluator logic operator ∀_{VLOGIC} may be defined (∀ indicates “anterior” and VLOGIC indicates “variable logic”). The logic operator function may an input permutation set and a variable logic requirement ν_{LOGIC} as an argument, and returns an output permutation set, as represented below:

$${φ}_{OUT} = {∀}_{VLOGIC} ( {φ}_{IN} , {v}_{LOGIC} )$$

Like anterior dependency requirements, anterior variable logic requirements correspond to recursive operations that result in permutation proliferation. The ∀_{LOGIC} operator may intake an input permutation set, and expand it to copies of the input set that have posterior variable setting requirements/entanglements added to the permutation set copies. All variable logic expressions have a fixed number of possible outcomes. A package version's metadata may evaluate a Boolean variable setting to control whether a dependency applies, based on a logic (such as a control flow logic). For example, the transitive dependency to Package X of version 1.* may be applicable ‘if myPackage_UseFeatureA has been enabled (or is ‘True’), ‘else’ the transitive dependency to Package Y of version 1.* may be added/applicable.

To implement/determine the anterior variable logic requirements, the unification engine 124 may be configured to clone the incoming permutation set (which may be either the input permutation set or the output permutation set of the previous iteration) into two copies (into first and second cloned sets). For a first copy/the first cloned set, a recursive dependency operator ∀_{D}(φ_{CLONE1}, α=XYZ::X::1.*) may be executed, which expands the first cloned set with the additional transitive requirements of the condition when myPackage_UseFeatureA is true. Then, the posterior entanglement T|myPackage_UseFeatureA) is applied to all permutations in the resulting set, constraining the first cloned set to the posterior result myPackage_UseFeatureA=True. For a second copy/the second cloned set, the recursive dependency operator ∀_{D}(φ_{CLONE2},α=XYZ:: Y::1.*) may be executed, which expands the second cloned set with the additional transitive requirements of the condition when myPackage_UseFeatureA is False (or not True). Then, the posterior entanglement F|myPackage_UseFeatureA) is applied to all permutations in the resulting set, constraining the second cloned set to the posterior result myPackage_UseFeatureA=False. The two cloned permutation set (i.e., the first and the second copies) may be scalarly added to produce a new permutation set which captures all possible outcomes described by past requirements as well as the new conditional dependency requirement.

In such embodiments, variable evaluators may be loaded as Boolean functions, for use in if/else statements, or enumerate functions, for use in switch statements (or generally any control flow function). Further, the function used to evaluate the variable evaluator is located on the unification requirement tree, which may be variable being set by a parent package, or a variable evaluator.

For example, a particle 202 associated with package may conditionally include another package and set variables if a graphics processing unit (GPU) is available on the machine. The “variable” being evaluated may not be a traditional quantum variable, but rather a function that has been loaded which can execute and determine whether the current computer has a GPU.

The If/Else or Switch statements shown above are made in an “anterior requirement context,” which may hold dependency nodes 404, set variable nodes 412, and/or logic switch nodes 410, discussed previously in reference to FIGS. 4A to 4D. The anterior requirement contexts may be computed based on the (incoming) permutation set, sweeping through each anterior requirement in the context, recursively if required. Every context created by logic switch nodes 410 may also be anterior requirement contexts, which may hold further dependency nodes 404, set variable nodes 412, and/or logic switch nodes 410. A pseudo-code example of a branching set of anterior requirements which may be recursively located and added to the permutation is provided below:

| [DEPENDENCY] | AddDependency(Package Foo 1.*) |
|---|---|
| [VARIABLE_SET] | Foo_UseCoolFeature = true |
| [LOGIC_SWITCH] If(myPackage_UseFeatureA) | |
| [LOGIC_CASE] | { |
| [DEPENDENCY] | AddDependency(Package X 1.*) |
| [VARIABLE_SET] | useMyOtherPackage = false |
| [LOGIC_SWITCH] | switch(someOtherFeature) |
| [LOGIC_CASE] | case “Low”: |
| [DEPENDENCY] | AddDependency(Package Y |
| 1.*) | |
| [DEPENDENCY] | LowSubConfig = true |
| [LOGIC_CASE] | case “Medium”: |
| [DEPENDENCY] | AddDependency(Package Z |
| 1.*) | |
| [DEPENDENCY] | MediumSubConfig = true |
| [LOGIC_CASE] | case “High”: |
| [DEPENDENCY] | AddDependency(Package Z |
| 1.*) | |
| [DEPENDENCY] | HighSubConfig = true |
| } | |
| Else | |
| [LOGIC_CASE] | { |
| [DEPENDENCY] | AddDependency(Package Y 1.*) |

}

During the unification process, the anterior requirements in the example above may result in at least 4× proliferation of permutations, assuming that all target packages referenced by the dependencies have already been loaded. Each copy of the incoming permutation set may have posterior variable setting requirements/entanglements that are scalarly added to the permutation set copies, as shown:
[myPackage_UseFeatureA=true, someOtherFeature=“Low”]
[myPackage_UseFeatureA=true, someOtherFeature=“Medium”]
[myPackage_UseFeatureA=true, someOtherFeature=“High”]
[myPackage_UseFeatureA=false

Thus, ∀_{VLOGIC} makes recursive use of the top-level ∀_{D} operator, as well as the ∀_{VSET} operator, and additional transitive ∀_{VLOGIC} operators. A single anterior requirement set may specify nested ∀_{VLOGIC} operators, or sequential ∀_{VLOGIC} operators which are evaluated one after another in the permutation sweeping operation of that anterior requirement set. Once the anterior requirements with respect to dependencies, variable setters, and logic switches, a posterior dependency for α::v may be added as a scalar to the VSPTPS computed above.

In some embodiments, multiple versions of a package may have the exact same anterior requirement set, thereby providing an opportunity for further optimization. After the scalar addition of the posterior dependency to each VSPTPS, the resulting permutation sets may be guaranteed to be unique. However, if the dependencies and other transitive effects are the same, and the input permutation sets are the same (as they always will be), then the resulting VSPTPS may also be the same. In such cases, the VSPTPS may be computed once, and then re-used as needed.

In such embodiments, for each version of a where VSPTPS is to be computed, first a key or hash is computed that uniquely identifies all dependency requirements, variable settings, and logic switch statements of that version of a. For example, a string may be created that concatenates all dependencies and other transitive effects, and the string may be used as a key to evaluate whether the VSPTPS for the same transitive effects have already been computed for the current context, which also includes the current input permutation set φ_{IN,α∉}_{_{φIN}}. A dictionary is used to store precomputed results, with the keys as described and the corresponding values storing the computed VSPTPS.

After computing the key, if the VSPTPS is present in the dictionary, the resulting VSPTPS is cloned and reused, (as may be indicated/located by the passive nodes 405 in FIG. 4C). Again, despite the enormous complexity of this recursive computation, it is guaranteed to be the same, because the input permutation set φ_{IN,α∉}_{_{φIN}} is guaranteed to be the same, and all transitive effects are guaranteed to be the same. If the key is not found, then the VSPTPS is computed, and the result is stored in the dictionary. This dictionary may also be utilized during execution of the anterior requirement ∀_{D} operators. Hence, the unification engine 124 may reduce instances of redundant computation of the VSPTPS sets, where multiple versions of a package (or specific classical values 206 of the particle 202) have the same dependencies and transitive effects.

Once the VSPTPS is computed, the (version-specific) posterior dependency associated with the version/classical value α may be scalarly added to the VSPTPS, and then the original dependency requirement α may be added to the permutation set to complete the proliferation of new permutations given a posterior solution that the domain has unified to incorporate this version of the associated package in the associated target for α.

Further, the expansion operator function then performs a scalar addition of each of the resulting permutation sets computed above, from each version of α. In the scalar addition of two permutation sets, all permutations from each permutation set are simply concatenated together. The mathematical form of the expansion operator function ∈ₐ is as follows:

$${ϵ}_{α} ( {φ}_{IN , α ∉ φ IN} , α ) = \text{} α + {\sum }_{i = 0}^{N - 1} ( {\prod }_{l = 0}^{L - 1} ( {∀}_{VLOGIC} ( {\prod }_{v = 0}^{V - 1} {∀}_{V S E T} ( {\prod }_{j = 0}^{D - 1} ( {∀}_{D} ( ( {∀}_{D} ( {I}_{i} + \{ {φ}_{IN , a ∉ φ IN} \} ) , \text{} {d}_{0} ) ) , \text{} {∀}_{D} ( {π}_{j - 1} , \text{} {d}_{j} ) ) \text{} , {v}_{S E T , 0} ) , \text{} {∀}_{V S E T} ( {π}_{v - 1} , \text{} {v}_{S E T , v} ) ) , \text{} {v}_{LOGIC , 0} , {∀}_{VLOGIC} ( {π}_{l - 1} , {v}_{LOGIC , l} ) ) )$$

where Iᵢ is the “identity permutation set” for the i^{th} version of the package associated with α and contains only a version-specific posterior dependency for that version/classical value 206:

In this equation,

$${\prod }_{n = 0}^{N} ( A , B )$$

operator computes permutation set by starting with an inbound permutation set A, and then passing this permutation set sequentially into the operator specified by B from n=1 to N-1. In the evaluation of B, the term πₙ₋₁ is used to reference the result of the previous sequential result.

The centermost term may be most easily understood first:

$${\prod }_{j = 0}^{D - 1} ( {∀}_{D} ( ( ( {I}_{i} + \{ {φ}_{IN , a ∉ {φ}_{IN}} \} ) , {d}_{0} ) ) , {∀}_{D} ( {π}_{j - 1} , {d}_{j} ) )$$

In some embodiments, the dependency expansion operator may be computed with the incoming permutation set φ_{IN,α∉}_{_{φIN}} added to the identity permutation set corresponding to the current package version being expanded, operating with the first (j=0) dependency specified by this package version:

$${∀}_{D} ( ( ( {I}_{i} + \{ {φ}_{IN , α ∉ φ IN} \} ) , {d}_{0} ) )$$

The first result is fed sequentially into the B operator for j=1 to D-1, where D is the total number of anterior dependencies specified by this package version. The B operator computes the dependency expansion operator using the permutation set result from the previous sequential computation, for the current jth dependency, which is the permutation sweeping operation for anterior dependencies. The output of this term is the permutation set expansion from all anterior dependencies for this package version, computed recursively. Let that computed result be represented by the permutation set variable σ.

Subsequently, the next operator layer out is represented by:

$${\prod }_{v = 0}^{V - 1} {∀}_{V S E T} ( φ , {v}_{S E T , 0} ) , {∀}_{V S E T} ( {π}_{v - 1} , {v}_{S E T , v} )$$

The expression computes the variable setter operation on the previous result σ for the first variable setter ν_{SET,0}. Then, from v=1 to V-1, where ‘V’ is the total number of variable setters in this anterior requirement context, the variable setter operation is applied on the previous sequential result, with the next setter operation, which is the permutation sweeping operation for the anterior variable setter requirements. The computed result may be represented by the variable φ.

Similarly, the anterior variable logic operators are applied in sequence, beginning with the result from the previous inner layer, and iterating through computations with the next sequential variable logic. The result of the computed permutation set that has expanded from the initial φ_{IN,α∉}_{_{φIN}} permutation set for a specific package version's anterior requirement context, which is a version-specific post-transitive permutation set, may be provided as:

$${\prod }_{l = 0}^{L - 1} ( {∀}_{VLOGIC} ( φ ) , {v}_{LOGIC , 0} , {∀}_{VLOGIC} ( {π}_{l - 1} , {v}_{LOGIC , l} ) )$$

The outer summation term

$${\sum }_{i = 0}^{N - 1}$$

from 1=U to N-1 is the summation (scalar addition) of version-specific post-transitive permutation sets. For each summation term, the nested sequential and recursive operators may clone the input permutation set, which is indicated by the curly braces in the equation with {φ_{IN,α∉}_{_{φIN}}}.

For each version/classical value 206 of a package/particle 202 that is being depended on from another context, the input permutation is cloned ‘N’ times. Then each clone has the corresponding version-specific dependency added from the identity permutation set, which is then processed with permutation sweeping.

The expanded clones are then concatenated together, resulting in another permutation set. Finally, the original anterior dependency is scalarly added to this permutation set to create the final permutation set result for the dependency expansion operator, as represented below:

$${ϵ}_{α} ( {φ}_{IN , α ∉ φ IN} , α ) = α + {\sum }_{i = 0}^{N - 1} ( φ )$$

The described means to generate permutations apply to unification of non-side-by-side particles. The non-side-by-side particles are those particles that preclude actualization of the same particles 202 with different classical values 206 in the same target domain, such as different versions of the same package being installed in the same project simultaneously. For such non-side-by-side particles, the unification engine 124 may be configured to unify the particles 202 to exactly one classical value. For side-by-side particles (i.e. where the target domain permits particles 202 associated with different classical values 206 can be actualized concurrently), the unification engine 124 may be configured to unify the particles 202 to more than one classical value 206. For example, some software applications allow multiple versions to be installed to the computer (the “installed applications” target) simultaneously.

However, for side-by-side particles with N versions, there may be 2^{N}−1 ways that the side-by-side package can be unified. For example, if Package A were side-by-side, it could unify to (1.0.0), or (1.0.1), or (1.0.0 and 1.0.1), or (1.0.2), or (1.0.2 and 1.0.0), or (1.0.2 and 1.0.1), or (1.0.2, 1.0.1, and 1.0.0). Thus, there are seven different ways that Package A could be unified (2³−1=7). Such exponential growth of the permutations may make it infeasible to determine unified values for each permutation. In such embodiments, the entanglements specified for the particles 202 may be invariant, i.e., all entanglements for all quantum properties 204 may be the same. The unification engine 124 may be configured to generate the permutations based on dependencies indicated by the entanglements assigned to the particles 202, while ignoring the specific classical values 206 of the particles 202 to which the entanglements apply.

In embodiments with side-by-side dependencies, the scale of computation or the explosion of permutations may render the problem fundamentally unsolvable. The proliferation of dependencies may result in the domain being inherently under-constrained. Further, the unification logic in side-by-side settings becoming unable to give preference of one version over another, all solutions/permutations may be valid.

The unification process may be suitably adapted to minimizes the total number of versions that are unified, for a given set of dependency requirements. The unification process may impose constraints that side-by-side packages cannot have certain version-specific dependencies, to explosion of permutations. All versions of a side-by-side package may have the same dependencies (i.e. the dependencies are specified at the package level, not the version level).

With such constraints, the unification process implemented by the unification engine 124 may include side-by-side packages in the incremental finalization process as it goes down the acyclic dependency graph. Again, the process of constraining an under-constrained domain to a specific, “best” permutation is called “incremental finalization”, which is discussed subsequently in the present disclosure.

For side-by-side (SBS) target package permutation expansion, the expansion operator may be implemented as:

$${φ}_{OUT} = {∀}_{D} ( {φ}_{IN} , {α}_{SBS} )$$

Here, the input permutation set may be split up into sets that either reference or do not reference the target package/domain associated with α_{SBS}. For input permutations where α_{SBS} is already in the set, the dependency may be scalarly added:

$${∀}_{D} ( {φ}_{IN , α ∈ φ IN} , {α}_{SBS} ) = {φ}_{IN , α ∈ φ IN} + {α}_{SBS}$$

For input permutations where α_{SBS} is not already in the set, the following side-by-side expansion operator is used:

$${∀}_{D} ( {φ}_{IN , α ∉ φ IN} , {α}_{SBS} ) = {ϵ}_{α SBS} ( {φ}_{IN , α ∉ φ IN} , {α}_{SBS} )$$

In such embodiments, the expansion operator may perform permutation sweeping on all dependencies of the package associated with α_{SBS}. Here, although the domain may allow different versions of the side-by-side package to co-exist, they must all have the same dependencies and transitive effects. Therefore, version-specific posterior dependencies are not used, and are not the basis for permutation proliferation. Additionally, permutation expansion caching (i.e., maintaining the dictionary of VSPTPS) is not required in side-by-side, as each dependency at the package level the side-by-side package is unique (there is no reason to make multiple identical dependencies).

In some embodiments, the non-side-by-side package may have anterior dependencies on side-by-side packages, and vice-versa. Thus, in these anterior dependency expansion functions, the appropriate expansion function is used based on the target package type. Wherever ∀_{D} is used, it is understood that the correct side-by-side or non-side-by-side dependency expansion operator is used as appropriate for the target package.

The final mathematical form of the side-by-side expansion operator function is then as shown below, using the φ placeholder variable, and where summation term is removed as there are no versions to sum over in the expansion.

$${ϵ}_{α , SBS} ( {φ}_{IN , α ∉ {φ}_{IN}} , {α}_{SBS} ) = α + {\prod }_{l = 0}^{L - 1} ( {∀}_{V L O G 1 C} ( {\prod }_{v = 0}^{V - 1} {∀}_{V S E T} ( φ , {v}_{SET , j} ) , {∀}_{V S E T} ( {π}_{v - 1} , {v}_{S E T , v} ) ) , {v}_{LOGIC , l} , {∀}_{VLOGIC} ( {π}_{l - 1} , {v}_{LOGIC , l} ) ) where φ = {\prod }_{j = 0}^{D - 1} ( {∀}_{D} ( ( ( {I}_{i} + \{ {φ}_{IN , α ∉ {φ}_{IN}} \} ) , {d}_{j} ) ) , {∀}_{D} ( {α}_{j - 1} , {d}_{j} ) )$$

As described, for each operator (whether they are dependency operator, variable setter operators, or logic switch operators), metadata (or other information) associated with the particles 202 may be located/identified in the unification requirement tree (as shown in FIGS. 4A to 4D). For example, when a dependency requirement is added by an ecosystem, the unification engine 124 may locate the package metadata for the associated package. Further, the unification engine 124 may determine whether the package/particle 202 is compatible with the installation target associated with its transitive parent. If the package is not compatible, then the intended installation target for the package must be resolved, as is the case with heterogeneous dependency graphs. In some embodiments, checking the compatibility involves the loading of various types of manifests produced by the packages and installation targets, in an arrangement that allows ecosystems of packages and installation targets to scale. It is desirable to efficiently load this information once, and reuse the manifests in the recursive operations in the unification process described above. Additionally, the unification engine 124 may also check for cyclicity in the dependency graphs.

Further, the expansion of permutation sets may involve repetitive cloning of objects which include things like unification logic objects and other transitive effect objects.

### Trivial Example Revisited

Returning the example provided in FIG. 6, the final permutation set may be recomputed for the domain with one dependency α=XYZ:: Package A::1.*.

In the foregoing example, the input permutation set PIN is empty, thus there are no permutations in the set φ_{IN,α∈}_{_{φIN}}. The expansion operator Ex ensures that the output permutation set references the target package associated with our anterior package dependency. This, the unification engine 124 may compute ∈_{α}(φ_{IN,α∉}_{_{φIN}}) with φ_{IN,α∉}_{_{φIN}} being an empty permutation set.

To compute ∈ₐ, the unification engine 124 may begin with the first of the three versions of α's package A (i=0, or version 1.0.0 of Package A). The unification engine 124 may apply the permutation sweeping through all dependencies of version 1.0.0 of Package A, by determining the innermost product term over j, the dependency index for the first (i=0) version of package A. In the expansion operator, the unification engine 124 begins with the j=0 evaluation of the first operator within the product term represented by:

$${∀}_{D} ( ( ( {I}_{i} + \{ {φ}_{IN , α ∉ φ IN} \} ) , {d}_{j = 0} ) )$$

In this example, the identity set for package A's i=0 package version (1.0.0) is a permutation set with a XYZ::A unification logic kernel with a posterior dependency of XYZ::A::[1.0.0-1.0.0], which is added to {φ_{IN,α∉}_{_{φIN}}}.

However, since version 1.0.0 of Package A has no dependencies, the entire product operator for i=0 reduces the first permutation set input to term Iᵢ+{φ_{IN,α∉}_{_{φIN }, which reduces to I}}ᵢ when the non-associated input permutation set is null:

$${\prod }_{j = 0}^{D - 1} ( {∀}_{D} ( ( ( {I}_{i} + \{ {φ}_{IN , α ∉ φ IN} \} ) , {d}_{0} ) ) , {∀}_{D} ( {π}_{j = 1} , {d}_{j} ) ) = {I}_{i}$$

Subsequently, the variable setting permutation sweeping operator is shown below, with the previous Iᵢ substituted for the dependency permutation sweeping part of the original sub-equation. By definition, since the version 1.0.0 of Package A does not specify any variable settings, this reduces to equal the original input to this permutation sweep, which remains Iᵢ, as shown below:

$${\prod }_{v = 0}^{V - 1} {∀}_{VSET} ( {I}_{i} , {v}_{SET , 0} ) , {∀}_{VSET} ( {π}_{v - 1} , {v}_{SET , v} ) = {I}_{i}$$

After sweeping through all variable setting permutations, the variable logic evaluation permutation sweeping operator is shown below, with the previous Iᵢ substituted for the variable setting permutation sweeping part of the original sub-equation. By definition, since this version 1.0.0 of Package A does not specify any variable settings, this reduces to equal the original input to this permutation sweep, which remains Iᵢ, as shown below:

$${\prod }_{v = 0}^{V - 1} {∀}_{VLOGIC} ( {I}_{i} , {v}_{LOGIC , 0} ) , {∀}_{VLOGIC} ( {π}_{v - 1} , {v}_{LOGIC , v} ) = {I}_{i}$$

The sum term over all versions of Package A produces Iᵢ for each summed element, in this case resulting in an identity permutation set for Package A, because Package A has no dependencies, sets no variables, and defines no variables, and because the original input permutation set was an empty set. Hence, the identity permutation set may be represented as:

$${\sum }_{i = 0}^{N - 1} ( {I}_{i} ) = \{ {I}_{0} , {I}_{1} , {I}_{2} \}$$

The original anterior requirement α is then scalarly added to the resulting permutation set summation result {I₀, I₁, I₂}, resulting in the visualized permutation set shown in FIG. 6.

The example illustrated in FIG. 6 assumes that each version of the Package A does not have further transitive entanglements with other packages. Further, since the quantum properties 204 of the particles 202 remain a set of superposition until they are collapsed, the set of all permutations may be represented as the logical states σ of the particles 202.

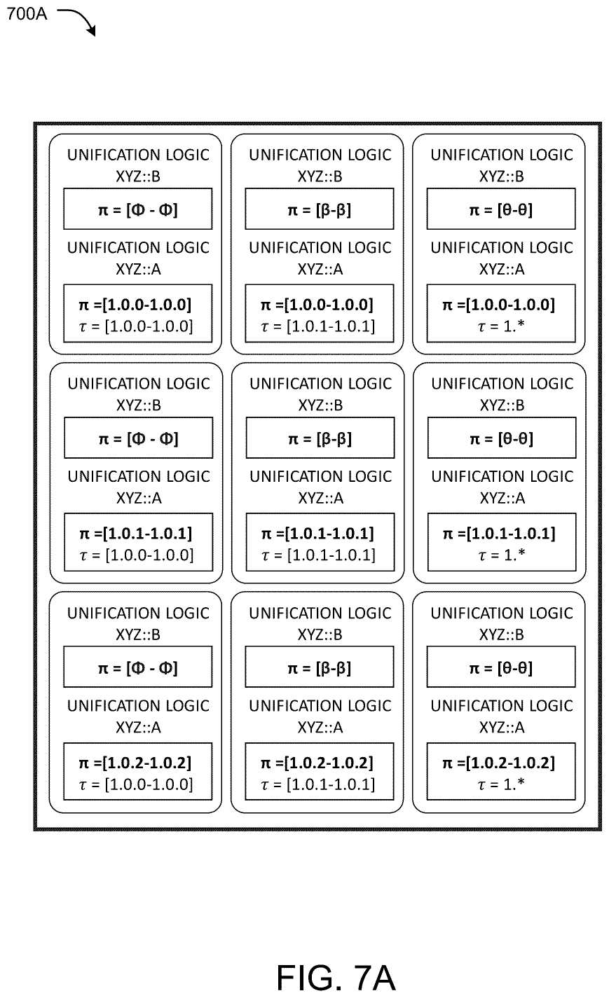

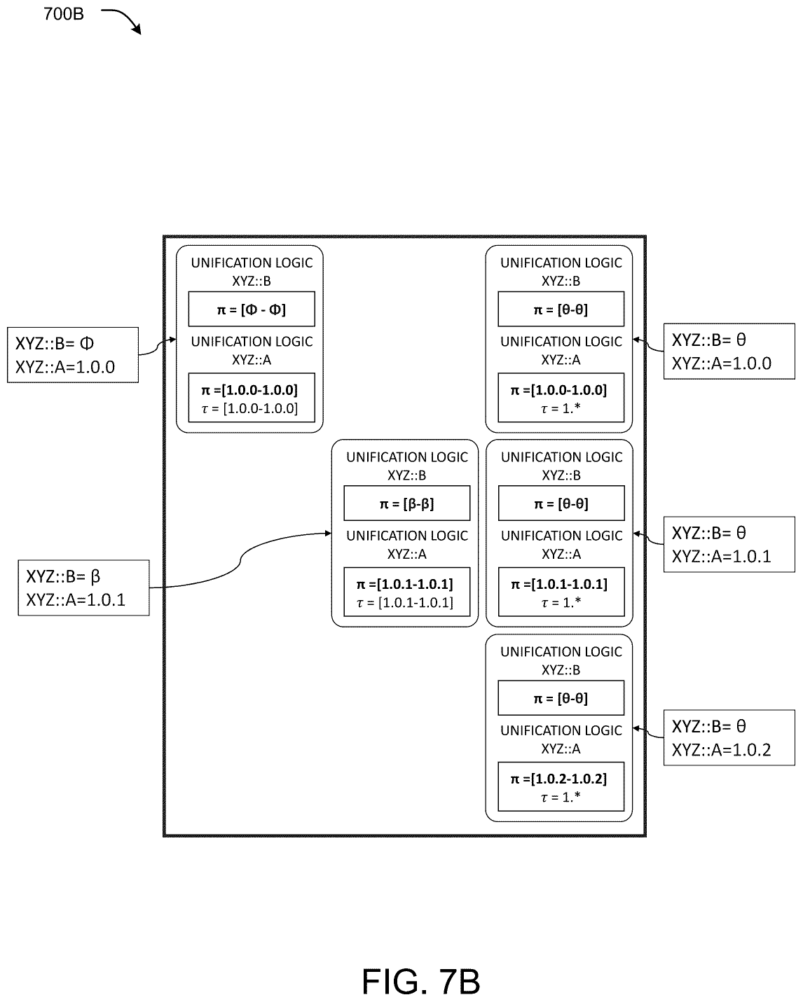

FIGS. 7A and 7B illustrate examples of determination of the permutations where the particles 202 have transitive entanglements. In the example shown in FIGS. 7A and 7B, a subset of versions of Package B may be dependent on Package A. Package B may have the possible versions Φ, β, and θ, with an ordinality of Φ→β→θ in increasing order (i.e., with oldest version on the left). Each version of Package B may be compatible with the target XYZ. In the example, it is assumed that Package B may have the following dependencies with Package A

Version Φ of Package B depends on version 1.0.0 of Package A;

Version β of Package B depends on version 1.0.1 of Package A; and

Version θ of Package B depends on version 1.* of Package A, * represents a wild card for the latest/newest version.

In such examples, the unification process (implemented at the unification engine 124) may include separating the original permutation set into associating subset and non-associating permutation subset:

$${∀}_{D} ( {φ}_{IN} , XYZ \text{::} B ∷ \text{*)} = ( {φ}_{IN , α ∈ φ IN} + XYZ ∷ B ∷ \text{*)} + {ϵ}_{α} ( {φ}_{IN , α ∉ φ IN} , XYZ ∷ B ∷ \text{*)}$$

Since φ_{IN} is an empty set, the first term vanishes (or is equated to a null value), because the scalar addition of an entanglement with an empty permutation set is an empty permutation set. The modified equation may be represented as follows:

$${∀}_{D} ( {φ}_{IN} , XYZ \text{::} B ∷ \text{*)} = {ϵ}_{α} ( null , XYZ ∷ B ∷ \text{*)}$$

The expansion operator ∈ₐ performs an innermost dependency expansion permutation sweeping, followed by variable setting expansion, followed by variable logic expansion, as described earlier. The inner dependency expansion permutation sweeping for this ∈_{α}(φ_{IN,α∉}_{_{φIN}}, XYZ::B::*) operator is as follows, with variable setting and logic expansion represented as ellipses to represent the vanishing variable set and variable logic expansion operators that have no effect when the package versions neither set nor use variables:

$${ϵ}_{α} ( {φ}_{IN , α ∉ φ IN} , α ) = α + {\sum }_{i = 0}^{N - 1} … ( {\prod }_{j = 0}^{D - 1} ( ( {∀}_{D} ( {I}_{i} , {d}_{0} ) , {∀}_{D} ( {π}_{j - 1} , {d}_{j} ) ) ) )$$

The expansion operator described above provides a top-level view of the recursive expansion operation. The summation term over the version indices ‘i’ for Package B combines the permutation expansion of each version of Package B into a single “orthogonal” permutation set, where the orthogonality is enforced by the application of the recursive ∀_{D}(Iᵢ, d₀) anterior identity dependency.

For visualization and conceptualization, the summation may be defined over the package versions in the index variable ‘i’ as a permutation “superset”, which keeps the version summation sets separate for the purposes of internal permutation sweeping, and reduces the summation sets back to a regular permutation set through scalar addition/summation, thereby enabling the version summation term and the internal expansion operations to be separately visualized. The innermost term then involves expansion of the identity permutation superset with an initial null permutation set. The initial identity permutation superset is created as three separate permutations corresponding to Iᵢ for i=0, 1, and 2, each with posterior dependency entanglements (viz., π=[Φ-Φ], π=[β-β], and π=[θ-θ] for Package B, where π corresponds to the posterior entanglement) applied to the corresponding logic kernel.

Based on the expansion, the input permutation may be cloned three times, and the identity permutation set from each permutation in the superset may be scalarly added to each clone, forming another superset (in the example shown in FIGS. 7A and 7B). For the case of a null input permutation set, the result of this scalar addition is the same identical identity permutation superset.

The superset may be expanded according to the first dependency expansion, for the first dependency specified by Package B, represented as:

$${\prod }_{j = 0}^{D - 1} ( {∀}_{D} ( [ I ] , [ {d}_{0} ] ) , {∀}_{D} ( {π}_{j - 1} , [ {d}_{j} ] ) )$$

The ‘i’ subscript is dropped from the identity permutation set input, and expressed in brackets and bold to indicate the superset which represents the expansion over all summation terms ‘i’. [I] is the identity permutation superset shown above, and [d₀] is the first entanglement specified by each version of B. This expansion occurs separately in the permutations in the superset, and the subsequent dependencies dⱼ specified by each version, which may be expanded independently in the permutation sets of the permutation superset.

In some examples, a first version of a package may have zero dependencies, in which case the expansion for the permutation set corresponding to that version returns the unaltered permutation set. A second package version may have one dependency, which results in a single anterior dependency expansion ∀_{D} for d₀. A third package version may have multiple dependencies, and require the subsequent permutation sweeping operations for dⱼ.

The use of permutation supersets may help visualize the entire expansion of permutations across all versions of the package. It should be understood that each term in the summation over the package versions corresponds to the VSPTPS described above.

In some embodiments, the input permutation set QIN may be isolated from the permutation sweeping, so that computation can be reused. For appropriately defined operators on permutation sets, the isolation may be achieved by taking a tensor product of the input permutation set with the expansion of the package's transitive effects against a null input permutation set, as shown below:

$${ϵ}_{a} ( {φ}_{IN , α ∉ φ IN} , α ) = α + {φ}_{IN} ⊗ {\sum }_{i = 0}^{N - 1} … ( {\prod }_{j = 0}^{D - 1} ( ( {∀}_{D} ( {I}_{i} , {d}_{0} ) , {∀}_{D} ( {π}_{j - 1} , {d}_{j} ) ) ) )$$

In some embodiments, the summation term may be precomputed and reused with an operator that combines the input permutation set PIN with the general transitive effects.

In some embodiments, the summation term may correspond to the package post-transitive permutation superset, which holds the VSPTPS for each version of the package in the given scope of the domain. With the package post-transitive permutation superset pre-computed, it may be reused for any instance of the particle 202. Once the existence of a particle 202 is postulated for the first time and expanded (by calculating its separable transitive effects joined by the quantum context defined by PIN through a tensor product operation, scalarly adding the entanglement, and computing the new quantum state for the current context), the next time a new instance of the same package is postulated, the separable transitive effects that were previously calculated may be reused.

However, the particle 202/package may be designed to be compatible with only one domain (for example, installation target type), or multiple domains. The example given previously is a package that delivers C++ code or precompiled libraries, which may be used in numerous project types. In such embodiments, the unification engine 124 may be configured to call a compatibility oracle associated with the unification logic, passing in the domain of the entangling particle as the default domain, to determine if any versions of the entangled particle are compatible with the logical domain of the entangling particle 202. If at least one version is compatible, then this logical domain is used for the transitively entangled particle.

If the entangled particle is incompatible with the logical domain of the entangling particle, then the entangled particle's metadata may be used to identify default logical domains, if any. The logical domains must be fully addressable so that the unification engine 124 can locate the heterogeneous logical domain target.

If the entangled particle is found to be incompatible with the logical domain of the entangling particle, but compatible with a default logical domain, then the entanglement context for the entangled particle may use the default logical domain. In such embodiments, the unification engine 124 may enable heterogeneous domain entanglement and allows, for example, software packages that are required to be installed into a project to require a software application, driver, software development kit, and so on, to be installed onto the computer that the project is being built in.

Thus, local domain resolution may be required when dealing with any non-root anterior entanglements. Since the resolved domain affects which particle versions of the particle 202, if any, that are compatible with the resolved logical domain, and the compatible versions vary, in general, from logical domain to logical domain, the package's post-transitive permutation superset is only valid for the logical domain that it was computed against, or any other logical domains that have identical manifests/characteristics.

To formally represent the checking of the logical domain compatibility and resolution, a delta function or operator is used which both checks for the compatibility of a given i^{th} version of the entangled particle 202 with respect to the entangling particle's domain context and attempts to find a compatible default logical domain if the i^{th} version of the entangled particle 202 is compatible with the entangling particle's domain. The delta operator may be understood to proceed with its second predicate operator if a logical domain is resolved for the entangled particle predicate of α. If the logical domain cannot be resolved, the delta operator returns an invalid or fault permutation, which causes any permutation set to become empty when taking the tensor product thereof with the fault permutation. The formal representation of the expansion operator with the delta function is shown below:

$${ϵ}_{α} ( {φ}_{IN , α ∉ φ IN} , α ) = α + {φ}_{IN} ⊗ {\sum }_{i = 0}^{N - 1} δ ( α , … ( {\prod }_{j = 0}^{D - 1} ( ( {∀}_{D} ( {I}_{i} , {d}_{0} ) , {∀}_{D} ( {π}_{j - 1} , {d}_{j} ) ) ) ) )$$

Returning to the example in FIGS. 7A and 7B, α may represent a requirement for Package B*, which may be installed into a .NET Framework version 4.5.1 project, for example. Versions Φ and β may have no dependencies, but version θ may have a dependency on a .NET Core version α library. Since a .NET Framework version 4.5.1 library is compatible with a .NET Core version α project, but a .NET Core version α library is not compatible with a .NET Framework version 4.5.1 project, version θ of Package B is incompatible with the logical domain and cannot be a resolved domain target. Hence, the expansion of Package B's package post-transitive permutation superset may not include permutations with version θ as a posterior dependency, or recursively include version θ's dependencies, variable settings, and variable selections.

After expanding XYZ::B::*, the unification engine 124 may be configured to apply the first anterior dependency (d₀) to the first version @ of B (i=0), which is the entanglement XYZ::A::[1.0.0-1.0.0], which corresponds to evaluation of ∀_{D}(Iᵢ, d₀) in the above equation. Since this version of the particle is compatible with the domain, the delta operator may be replaced with its second input argument. This resulting permutation set is then fed into all subsequent dependency entanglements for j=1 to D-1.

Since D=1 (version Φ of B only has one entanglement A::[1.0.0-1.0.0]), there are no subsequent dependency entanglements, and the result of this permutation sweeping term is the expansion of the A::[1.0.0-1.0.0] entanglement.

The anterior dependency expansion for the A::[1.0.0-1.0.0] entanglement follows the same expansion process. The culmination of the entire permutation proliferation and calculation process for all versions and dependencies, after the permutation sets of the supersets are concatenated are shown in FIG. 7A. The permutation set results in four invalid permutations and 5 valid permutations, with their corresponding unified values shown in FIG. 7B.

Based on the constraints imposed by the posterior entanglements and the transitive entanglements, the number of unified/unifiable permutations may vary. If there are 0 unifiable permutations that result, then the unification engine 124 may fail to unify since the entanglements “over-constrain” the quantum configuration space of the particles 202. If the result is exactly one unifiable permutation, then the entanglements “critically constrain” the configuration space of the particles 202, which may be desirable for most practical applications. If the result is more than one unifiable permutation (such as in the example shown in FIG. 7B where α permutations are valid), then the entanglements “under-constrain” the quantum configuration space of the particles 202. In such embodiments, the unification engine 124 may be configured to add additional anterior entanglements to critically constrain the state space of the particles 202, or incrementally collapse the quantum properties 204 of the particles 202 to select/determine the “best” permutation. In some embodiments, the additional anterior entanglements may be a user selection received from the user 106, a heuristic selection determined either by the user 106 or by the developer 102 associated with the particles 202, and/or through random selection of at least one of the permutations.

In some embodiments, the unification engine 124 may be configured to identify all possible/compatible permutations from the set of permutations 22. In such embodiment, if the number of permutations satisfying all the entanglements is greater than 1 (indicating that the particles 202 are under-constrained), then the unification engine 124 may be configured add further entanglements to critically constrain the particles 202. In other embodiments, the unification engine 14 may be configured to terminate generating further permutations on finding the first compatible permutation, based on the requirements.

### Optimized Method

Individually representing each possible permutation based on the anterior and the transitive entanglements may become computationally infeasible as the number of quantum properties 204 and the possible classical values 206 therefore increase. For example, in a sudoku puzzle, 81 cells may be arranged in 9 rows and 9 columns. These cells also form 9 groups of 9 cells arranged in a 3×3 grid. The puzzle is solved when a number from 1 to 9 is placed in each cell in the 81-cell grid. In addition, the same number cannot be used twice in any row, grid, or group. In the meta-quantum mechanical paradigm, the grid may represent a target domain including 81 particles, each with a quantum property having 9 possible classical values. In such examples, the state space may include a total of 981 theoretical permutations. While in typical sudoku puzzle, an initial set of constraints (i.e. anterior entanglements) are provided as prefilled cells which reduce the size of the state space, the state space may still be larger than processing and/or memory capabilities of most computing devices. Further, the number of transitive entanglements required to constrain the state space and unify the particles 202 may also increase at least with exponential complexity. For example, every cell/particle 202 in the grid directly entangles with exactly 24 other cells in the grid (8 same-row entanglements, 8 same-column entanglements, and 8 same-group entanglements), thereby implying at least 24*81=1,944 quantum entanglements built into the rules of the puzzle.

To address such combinatorically exploding state spaces and entanglements, the system 110 may be configured to generate a particle entanglement map, as shown in FIGS. 8A to 8C, based on the dependency graph. The particle entanglement map may be used to represent the anterior entanglements and the transitive entanglements. When incrementally collapsing the predefined particles 202 and the dependency particles thereof to obtain the at least one permutation, the particle entanglement map may be used for identifying the entanglement associated with the particle 202 being collapsed. Based on the value to which the (first) quantum properties 204 of the particles 202 are collapsed, the unification engine 124 may identify the other dependency particles thereof based on the transitive entanglements, and accordingly collapse the (second) quantum properties 204 of said dependency particles. The use of the particle entanglement map reduces the computational resources required to collapse the entire domain. Further, by allowing the unification engine 124 to selectively apply the anterior and/or transitive entanglements for specific classical values of the quantum properties, the particle entanglement map also reduces the memory required for storing the permutations.

The particle entanglement maps 800A to 800C of FIGS. 8A to 8C uses the example requiring unification of the following packages: Packages A, B, C, and D each having versions 1.0.0 and 1.0.1, and the following entanglements specified for each version:
A 1.0.0:B1.0.0, C1.0.0
A 1.0.1:B1.*, C1.*
B1.0.0: D 1.*
B1.0.1: D 1.0.1
D 1.0.0:[None]
D 1.0.1:[None]
C1.0.0: D 1.*
C1.0.1: D 1.0.1

As shown in FIG. 8A, the particle 202-1 to 202-4 may be associated with software packages A to D, respectively. Each particle 202 may have one quantum property 204 corresponding to the version of the software package. The possible classical values 206 for each package are provided in FIG. 8A. Each permutation σ is represented as a unique path through all the particles 202 connecting through the horizontal arrows. Further, the vertical arrows connecting posterior and transitive entanglements to specific classical values of other packages indicate the quantum contexts 208 of the posterior and transitive entanglements associated with the particle 202. At least one of the logic kernels (represented using Kr) may be assigned to each particle 202 to evaluate the compatibility of the classical values 206 with the anterior, posterior, and transitive entanglements associated with the particles 202.

As an example, for a permutation where Package A is version 1.0.0, there may exist entanglements to Package B1.0.0 and Package C1.0.0, as well as an anterior entanglement α₁. The anterior entanglement α₁, with no connecting vertical lines, has no quantum context, and therefore the entanglement always applies to all permutations. The thicker line connecting Iₐ to the particle 202 may be indicative of an identity entanglement that represents a version-specific posterior entanglement for each possible classical value 206 of the particle 202. The identity entanglements may be used to force the logic kernel to either evaluate the quantum property 204 to the classical value 206 (such as the version) for the corresponding permutation or invalidate the permutation. As shown in representation 800D of FIG. 8D, the identity entanglements may be used to represent the posterior entanglements associated with quantum properties 204 of the particle 202.

In the above example, the total number of possible permutations is only 24=16 permutations. However, as the number of particles 202, the quantum properties 204, and the possible classical values 204 therefore grows, the number of permutations may grow at least with exponential complexity. For example, two quantum properties, viz. PackageA_Foo and PackageA_Bar (which are abbreviated to PkgA_Foo and PkgA_Bar, respectively in FIGS. 8B and 8C), may be added to Package A whose classical values 206 include Boolean values “True” and “False”. The PackageA Foo and PackageA Bar may be used to indicate if Package A is configured to implement feature ‘Foo’ or feature ‘Bar “, or both, where each feature may require a different set of dependencies/packages for Package A. Such dependencies may be expressed using conditional entanglements. For instance, if PkgA_Foo is True (as may be specified in the anterior entanglement), Package A may require version 1.0.0 of Package C to be installed, and may require PackageB_Active to be True. If PackageA_Foo is False and PackageA_Bar is True, then Package A may require version 1.* of package D to be installed. If both PackageA_Foo and PackageA_Bar are False, then Package A may require version 1.* of Package E to be installed. In such examples, the number of permutations quadruples to 64 permutations, indicating that the permutations increase exponentially with each increase in quantum configuration properties. The particle entanglement map 800B shown in FIG. 8B illustrates a compact relational representation of the particle properties and the anterior, posterior, and transitive entanglements thereof in accordance with the foregoing example. The particle entanglement map 800B is split into two rows for clarity.

The particle entanglement map 800B in FIG. 8B may provide a memory-efficient and compact mapping of quantum configuration which allows quantum scripts to describe quantum entanglements on other quantum properties, in the quantum context 208 of a particular set of quantum property 204 decohering to a particular set of corresponding classical values 206. The particle entanglement map 800C in FIG. 8C shows only the entanglement condition relationships.

As shown in FIG. 8C, each entanglement node applies to a given permutation only when the connections from the entanglement to the classical values of the particle properties match the classical values associated with the given permutation. For example, the entanglement for Package B1.* in the top row may apply for all permutations that have Package A decohering/collapsing to version 1.0.1. Similarly, the entanglement for Package D 1.* in the top row may apply when Package A is version 1.0.0, PackageA_Foo is False, and PackageA_Bar is True. The entanglement for Package E 1. in the top row may apply when Package A is version 1.0.0, PackageA_Foo is False, and PackageA_Bar is False. By limiting the application of the entanglements based on the permutations (or the specific classical value selected for the permutation), the unification engine 124 may be able to unify the particles 202 with reduced computational resources.

The thicker bold lines between the identity entanglements/x and its connected particle 202 provide a compact representation of N posterior entanglements for the N different possible values of the particle's quantum state, with each entanglement connecting to a different permutation node representing that quantum state. Since each of these entanglements have only one conditional entanglement indicated by corresponding line, they are only conditioned on one version, and function as the posterior entanglement applied to the logic kernel for that permutation, forcing the permutation to converge to that version or have a conflict.

The particle entanglement map may be computed to map entanglements between the particles 202 of the quantum ensemble/meta-quantum mechanical system, such that when permutations are being iterated, the entanglements that apply to that permutation may be efficiently determined/retrieved. The particle entanglement map may enable the entanglements to be represented and used by the unification engine 124 based on a declarative and nested quantum script used by the user 106 to generate the request. The permutation entanglement map further enables permutations to not have to be stored in the memory 114, with their respective entanglements, as the relevant entanglements may be retrievable from the particle entanglement map in real time or during inference-time, and improving the performance/operation of computing devices that implement the system 110. While the present disclosure describes the use of the particle entanglement map, it may be appreciated by those skilled in the art that any other data structure or representation may be used for identifying entanglements associated with each possible classical value and accordingly determine the set of permutations.

### Incremental Collapse

As described earlier, after evaluation of validity (or internal consistency) of the permutations at the logic kernels, the unification engine 124 may have any one of critically-constrained solutions (i.e., having one valid permutation), over constrained solutions (i.e., having no valid permutation), or under-constrained (i.e., having more than one valid permutation). In some embodiments, the unification engine 124 may be configured to incrementally collapse the quantum properties 204 of the particles 202 to specific classical values 206, to identify the “best” permutation in the under-constrained set of permutations. The present disclosure provides for collapsing a quantum ensemble efficiently. A quantum property 204, if collapsed too early, may result in wasted computation and memory evaluating permutations that may be invalidated with less effort. The optimal value oracle described earlier, provided by the logic kernel of the quantum property 204, may represent a specific implied quantum logical deduction when used to determine the best value. The unification engine 124 may be configured to use any one of the following deductive reasoning approaches to reduce the number of permutations evaluated, thereby optimizing computational resources.

When the quantum property 204 is collapsed through a ‘local collapse’, there are entanglement sets corresponding to each classical value 206, where each of the said entanglement sets include a posterior entanglement which constrains the corresponding permutations to the given specific classical value 206. Each entanglement set corresponding to one of the classical values 206 may involve a different entanglement set, as may be appreciated in the permutation expansion/proliferation process described in reference to FIGS. 6 to 7B. The optimal oracle determines/provides the “best” unified version for each applicable unique set of entanglements. As shown in FIG. 7B, more than one entanglement set that predicates the given quantum property 204 may result in different optimal values by the optimal oracle, because of differences in entanglements. The unification engine 124 may determine the overall “best” version through a deduction: when more than one entanglement set produces a best value, the overall “best” value may be taken by disabling posterior entanglements and then providing the entanglement sets again to the optimal oracle. In some embodiments, all entanglement sets may result in a different optimal value except for the one corresponding to the best overall classical value 206. In such embodiments, optimal oracles may be simply implemented as independent quantum ensemble aspects, without performing more complex cross-entanglement set analysis, which the unification engine 124 may perform, such as when incrementally collapsing the particles 202 in the quantum ensemble after permutation proliferation.

In some embodiments, the quantum properties 204 may be collapsed based on the domain dependency graph, such as those shown in FIGS. 5A and 5B. Individual under-constrained logic kernels may be collapsed by taking the “best” kernel output from all valid permutations, while maintaining a separation of concerns between the logic kernel, the entanglement logic, and the entanglement joining concerns, using posterior version- or classical value-specific entanglements. Due the transitive nature of the entanglements, collapsing logic kernels deeper in the domain dependency graph first may result in constraints that cause the domain to fail to unify to the best version, or may result in resolution interactions being presented to the user 108 that may be irrelevant. For example, a particle 202 corresponding to Package A may use a Boolean property “Foo” to conditionally entangle particle 202 corresponding to Package B when Foo is true. If the version of Package B is finalized first by presenting the user with an interaction, and then “Foo” is finalized to false from a user interaction, the original interaction to finalize B should never have been presented.

Hence, the unification engine 124 may be configured to select the order of collapsing the quantum properties 204 beginning from the logic kernels that are referenced at the root level, with no non-root entanglements on the logic kernel, which may be either a particle version kernel or a configuration variable kernel. The dependency graph may be recursively evaluated to find logic kernels that have entanglements applied to finalized, or critically constrained, logic kernels, until all kernels are incrementally finalized.

In some embodiments, each kernel has a measurable meta-property called “Entanglement Level”, which may be the smallest number of entanglement segments in the domain dependency graph that reaches the root level. Logic kernels directly referenced by a root anterior entanglement have an entanglement level of 0. If that logic kernel's particle 202 has an entanglement with another logic kernel, that logic kernel may have (or be assigned) a level of 1, and so on, unless an additional root anterior entanglement was applied to that kernel, in which case such logic kernels may also have an entanglement level of 0. The logic kernels may also have a meta-property called “Finalization Level”, which may be the smallest number of entanglement segments in the domain dependency graph that reaches either the root level or a critically constrained kernel. The logic kernels that are critically constrained have a finalization level of 0. During incremental finalization, logic kernels with a finalization level of 1 may be recursively incrementally finalized, until all kernels are finalized and have a finalization level value of 0. The logic kernels to collapse may be selected based on either the entanglement level or the finalization level, or both. For example, the logic kernels having the lowest entanglement level or the finalization level may be selected for recursive/incremental finalization.

In some embodiments, the incremental collapse process may leverage the interaction information provided by the particle creators/developers 102 and associated ecosystems to bring a domain to the critically constrained state. Anterior root requirements/requests drive the permutation proliferation and culling/pruning process, and results in either an over-constrained, critically constrained, or under-constrained tentative state. In other embodiments, a user interaction is presented to the user 106, allowing them to select/choose a finalizing version which is not critically constrained from the current set of root anterior requirements and their transitive effects.

In further embodiments, configuration variables may be defined in such a way as to automatically finalize when under-constrained, or may require a user interaction for the user to select the state of the under-constrained variable. When another root request is made by the user 106, creating a new unit of work, the automatic finalization process may be discarded, and the new constraints may be unified. The automatic finalization is re-applied after the new constrained have been unified. When a user 106 provides a manual selection to finalize a logic kernel, they may have the option of selecting a temporary entanglement or a new root entanglement. When the selection is a temporary entanglement, the unification engine 124 ignores the entanglement when unifying new requests, and may be configured to use the temporary entanglement if found to be useful for critically constraining the domain during incremental finalization. If the variable selection/finalization entanglement creates a conflict with new root entanglements, the variable selection is discarded.

In other embodiments, systematic quantum collapse may leverage more implied deductive reasoning. In some embodiments, a specific quantum property 204 may be selected/readied to be locally collapsed only when no entanglements that predicate the quantum property 204 are in a state of quantum superposition. In such embodiments, the entanglements on the quantum property 204 are all anterior entanglements, and thus have no quantum context 208 and are not held in superposition, or the given quantum properties 204 forming the quantum contexts 208 for all entanglements have pre-transitive quantum properties that have all already been collapsed, thus ensuring that the entanglements themselves are not in a state of superposition.

When the entanglements on a quantum property 204 are not in superposition, the quantum ensemble itself may still be in a high-dimensional superposition, but there may be at least one entanglement set corresponding to each classical value 206 of the locally collapsible quantum property 204, and all permutations of the quantum ensemble may specify entanglement sets corresponding to one of the classical values 206, with corresponding posterior entanglements applied by the quantum ensemble.

In such embodiments, the unification engine 124 may rely on the above deductive reasoning to determine that while the quantum property 204 is still in a state of superposition, all entanglements on the quantum property 204 are not in superposition, and the quantum property 204 may be collapsed by use of the optimal oracle as described above. Locally collapsing a quantum property 204 may include a deductive proof that at least one valid permutation (covering the entire quantum ensemble) for the “locally best” classical particle value 206 exists. A “local deductive proof” is a proof that may be evaluated in the context of a single logic kernel. A “non-local deductive proof”′ is a proof that may only be evaluated in the context of several logic kernels. A “non-local validation proof” may seek to validate a specific classical value 206 as the collapsed value for the quantum property 204, by combining the primary proof that it is the locally best available classical value 206 that has not been invalidated (an easily determined local proof), and the secondary proof that at least one permutation incorporating all other logic kernels of the domain is valid (a non-local proof). This is called an “iterating proof”, because to prove the local collapse logic for the current best classical value 206, it must temporarily hold this quantum property 204 to the tentative best classical value 206 for the quantum ensemble, and then proceed to incrementally collapse all other quantum properties 204, until at least one valid permutation is found. In this operation, the “best permutation” need not be found, only “a” valid permutation, which satisfies the top-level local collapse secondary proof logic, needs to be found. In such embodiments, the unification engine 124 may be configured to determine at least one validating or non-validating classical value 206 for the quantum properties 204 based on the anterior and/or transitive entanglements thereof, based on which the set of permutations may be generated. The set of permutations may include permutations where at least one of the quantum properties 204 is collapsed to the validating classical value 206, or does not include any of the non-validating classical values. The quantum properties 204 may be incrementally collapsed to values in the valid permutations in the set of permutations determined.

The secondary proof logic strategy may be appreciated to be the same strategy as what was previously described as the “top strategy”: the next quantum property 204 with all predicating entanglements now in a collapsed state may be locally collapsed. In some embodiments, incrementally collapsing the quantum properties 204 may include locally collapsing a next quantum property having a set of predicating entanglements associated with the previously collapsed quantum property. The predicating entanglements may include at least one logical entanglement from that entangle the next quantum property with the classical value of the quantum property 204 which are in a collapsed state. However, it may be appreciated that at every stage of incremental collapse, the non-local incremental collapse strategy is the most computationally expensive strategy.

Returning to the puzzle sudoku example, there are a variety of deductive reasonings that may be used to collapse the quantum logical system. In general, deductive reasonings may be “validating” or “invalidating” deductive reasonings which prove that a specific (validating or invalidating) classical value 206 must be the collapsed value, or which prove that a specified classical value 206 cannot be the collapsed value, respectively, in a specific collapse context. Deductive reasonings may also be local, meaning they only evaluate entanglements and previous deductive proofs corresponding to the quantum property 204 being collapsed, or non-local, meaning entanglements and previous deductive proofs relating to the quantum properties 204 other than the quantum property 204 that the given deducting logic is applied to either validate or invalidate.

In the present disclosure, the logic kernels provided to the system 110/unification engine 124 may be extensible deductive reasoning aspects that the system 110 uses to efficiently collapse the quantum ensemble. The system 110 may continue to apply non-iterating deductive reasoning provided by the logic kernels, until all non-iterating deductive reasonings have been applied without any successful validating or invalidating proofs. Then the system 110 may proceed to iterating deductive reasonings provided by the kernel to collapse the particle 202. The use of validation and invalidation proofs may eliminate the need for the logic kernel to evaluate all permutations, but rather a subset of permutations. The subset of permutations may be known to either include only known valid permutations, or not include known invalid permutations, thereby saving computational resources both in terms of processing/computation required, and memory.

With the sudoku puzzle as a reference, it may be appreciated by those skilled in the art that other deductive reasonings that may be used to solve sudoku puzzles, such as “Last Free Cell”, “Last Remaining Cell”, “Last Possible Number”, “Obvious Pairs”, and so on, are either validating or invalidating proofs that map directly to the system 110. For example, if certain numbers are prelisted in rows, columns, and or block/cell group entangled with a cell of a sudoku puzzle, the possible classical values 206 that the cell can collapse to may be limited to numbers other than the prelisted numbers. In such examples, the unification engine 124 need not generate permutations, not evaluate the entanglements thereof for consistency with the anterior or transitive requirements/entanglements corresponding to the possible classical values 206 in the prelisted numbers, thereby significantly reducing computational complexity and memory requirements. Accordingly, the system 110 may be designed to efficiently solve the hardest meta-quantum logical problems that arise spontaneously through self-expressing composable quantum ensemble aspects. The deductive reasoning approach may reduce the computational and memory resources required during unification, as determining the validating or non-validating classical values 206 using the deductive reasoning means described above may preclude the need to generate and evaluate permutations that either do not have validating classical values or have non-validating classical values 206 for incrementally collapsing the particles 202.

It may be appreciated that some non-version quantum properties 204 may provide a classical value rank preference order, such as a quantum Boolean configuration variable that specifies a default value, and thus the system 110 may use a so-called “Rank Proof”′ deduction. Others may specify no rank preference order, as in the case of a quantum Boolean configuration variable with no default. When no rank preference order or classical value ordinality is specified by a quantum property's logic kernel, a so-called “Non-Rank Proof” deduction or action is needed to collapse the property. When no deductions are found to collapse the quantum property 204, the unification engine 124 may prompt the user 106 to select to collapse the quantum property 204 to a desired classical value, or apply a heuristic to automatically collapse the quantum property 204, or select a classical value 206 at random.

### Actualization

In some embodiments, the system 110 may be configured to actualize the particles 202 based on the determined classical values. In the foregoing examples pertaining to the unification of software packages, unification of the particles 202 may yield the classical values indicative of package versions for the corresponding software packages. The system 110 may be configured to actualize the particles/software packages by installing the determined classical values/versions of the software packages, or generating a build system for the software in the package version, including the determined versions of the dependencies of the software packages requested by the user 106, in the user device 108. When the system 110 (or the unification engine 124) is implemented within the user device 108, the packages may be installed after the unification is complete. When the system 110 is external to the user device 108, such as when the system 110 is an external (quantum) computing device, the system 110 may transmit the classical values pertaining to the versions of the packages (including the dependencies) to the user device 108, which may install the determined versions of the packages. Installing packages may, among other steps, include loading the packages to memory, running installation commands (or corresponding processor-executable instructions), accepting licenses associated with the package, and extracting, compiling, and executing instructions in the package. Files, binaries, libraries, dependencies, and/or data associated with the package may further be stored in main storage or temporary storage devices of user devices 108, in the form of executable files, databases, caches, shared storage, and the like.

In some embodiments, the particles 202 may be enabled for actualization on satisfaction of the policy requirements assigned to each of the particles. The policy requirements may be enforced for governance. Governance may include both user-side and particle creator/developer-side governance. For user-side governance, an organization may specify policies that restrict the use of certain particles based on digitally signed claims, or other policy mechanics. For example, an organization using particles may enforce a policy that does not allow particles that represent open-source software packages, which may pose security vulnerability risks or legal licensing risks.

As stated, the users 106 may not know the dependency implications (i.e. the transitive entanglements applicable to the particles 202) of their top-level requests at the time they are made. Thus, when the particles 202 are collapsed and the one or more failing policy requirements for actualizing the particles 202 are identified, the policy requirement resolution actions may be presented to the users 106, such as on the display interface of the user device 108. The user 106 may assess and take actions to satisfy the policy requirements. For example, the users 106 may purchase products or licenses from the developers 102, accept end-user license agreements, make self-attestations regarding claims such as student or professional status, preclude actualization of open-source licenses (such as of contagious open-source licenses), and so on. Presenting the policy requirements as and when identified may allow the users 106 to decide whether the particle 202 is to be actualized. For example, if a software package requires the purchase of a $20,000 license to actualize the particle 202, which the user 106 is notified of after the request is made, the user 106 may select another software package to be installed that has less arduous policy requirements. Further, unification using the meta-quantum mechanical paradigm may allow the policy requirements of all the particles 202 to be identified before actualization (since the permutation that satisfies all the logical entanglements include the unified classical values for all the particles 202), thereby providing the users 106 with the option of selecting a permutation of classical values for the particles 202 that have favorable policy requirements.

In an example, the particles 202 may be used to represent top-level digital twins of a space station or satellite. The top-level particle may be developed by subject matter experts in space station or satellite design and operations, using third party particles which the top-level author does not own or have distribution rights to, or which involve deep domain expertise. When the user 106 issues the request to “use” or “install” the digital twin, with no ability to understand the details involved in using the digital twin or its transitive entanglements, the system 110 may unify the request with the user's domain. The unification may involve the user 106 being prompted with questions to methodically work through all the details of the user's requirements. Such incremental finalization process may be orchestrated by the system 110, but using information provided by all particle developers 102.

After the request is unified, the particle 202 in the request may result in hundreds of transitive/dependency particle requests. After finalization of all the particles 202, the system 110 may determine if the policy requirements associated with the particles 202 have been satisfied for governance. If 20 out of 200 particles contributing to the digital twin of the satellite require software licenses to be purchased, this information is consolidated at the end of unification and presented to the user 106. The users 106 may either take actions to satisfy the policy requirements or select other particles having different or no policy requirements. For example, the user 106 may find alternatives for software packages that specify open-source libraries that may violate an organization's policies. The user 106's organization may specify a policy requiring digitally signed claims attesting to the trustworthiness and provenance of all software packages used in the target domain from a trusted digitally signed claim issuer. After the policy requirements are satisfied, the system 110 proceeds to the “installation”, “actualization”, or “realization” of the particles 202 based on the unified classical values.

As stated, since the particles 202 may be used to represent any physical or virtual artifacts, the use of meta-quantum mechanical paradigms may have applications in a plurality of domains. For example, the particles 202 may be used to represent Boolean variables to solve Boolean satisfiability expressions/problems, traveling salesman problem, and generally any problem that requires determination of a combination of values for multiple variables with combinatorically exploding state spaces.

Further examples may include receiving request from the user 106 to identify optimal routes between two or more locations, subject to one or more constraints. In such examples, the particles 202 may be used to represent multiple routes between the locations in a map, and the entanglements may correspond to the constraints and/or relationship between two or more routes. The system 110 may unify the quantum properties of such particles 202, and determine the possible (optimal) routes.

In some implementations, the system 110 may be configured to transmit API signals to other computing devices that execute a predetermined set of functions based on the payload information and/or type of the API signal. For example, when the particles 202 are implemented for identifying optimal routes between two or more locations, the system 110 may be configured to unify the particles 101 to obtain classical values representing the routes, which may be transmitted to the user device 108. The user device 108 may overlay the determined route on a display interface thereof.

In other examples, the particles 202 may be collapsed to identify a chess move for a given position. The determined chess move may then be transmitted to the user device 108 through the API signal. In such examples, the particles 202 may be used by chess engines to determine best moves for given positions.

In further examples, the particles 202 may correspond to different aspects of composable business packaged capabilities used as the backbone for an enterprise integration system. The enterprise integration system may be created as a resilient and flexible core business process, easily adaptable to new capabilities and business environments.

In still further examples, the particles 202 may correspond to disparate applications that may be orchestrated to solve specific problems. A camera particle and a computer vision classification particle may entangle with a video feed interface particle, allowing independent camera and computer vision capabilities to be integrated through self-orchestrating particles. The computer vision classification output and a process controller may entangle with a common particle for defining digital process states, enabling manufacturing processes mash-ups to be created. In these cases, the core business problem of each individual capability (the transaction cost of integrating that capability with other capabilities) is removed from those capability providers and from the end user by the system 110 of the present disclosure. In further examples, the particles 202 may correspond to composable and configurable “packaged capabilities” used to create flight simulators. Each aspect of the flight simulator may be represented, including hardware-in-the-loop (throttle quadrants, yokes, etc.), analog gauges, digital gauges, and the like, as well as capabilities for connecting the data sources and sinks using protocols such as Message Queuing Telemetry Transport (MQTT). Without the system 110, bespoke flight simulators, including distributed applications (multiple display applications in the cockpit, a central server application which runs the simulation) may be cost-prohibitive due to the complete redevelopment effort for every unique aircraft. Using the system 110 of the present disclosure, every composable and configurable aspect of the flight simulator may be independently released to production, and a custom flight simulator may be created and customized in a “mashup” at a reduced costs in comparison to bespoke flight simulators. The flight simulator may be built from internal “self-serve” self-orchestrating particles or leverage an open digital ecosystem of self-orchestrating and networking particles.

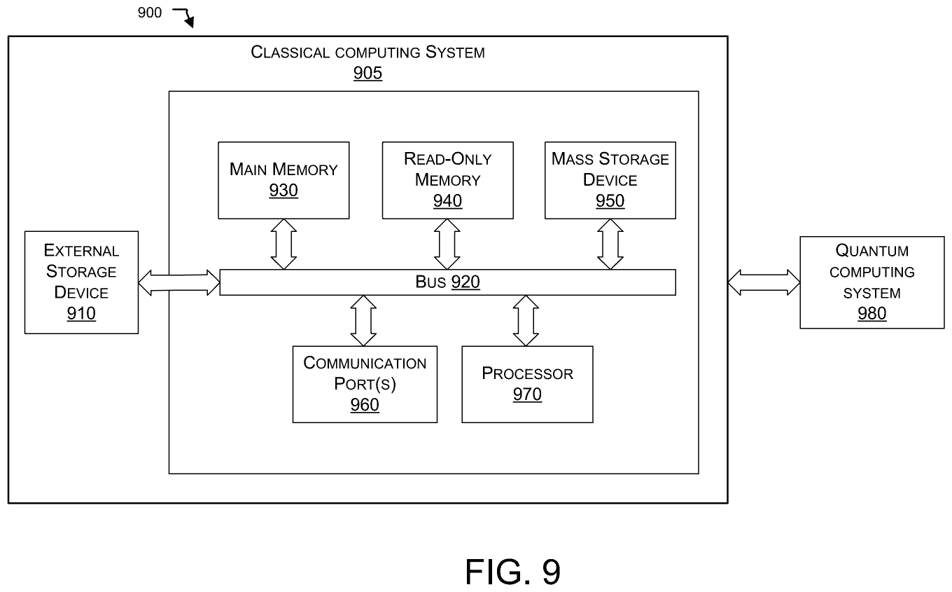

FIG. 9 illustrates an exemplary computer system 900 in which or with which embodiments of the present disclosure can be utilized in. As shown in FIG. 9, the computer system 900 may include a classical computing system 905 having an external storage device 910, a bus 920, a main memory 930, a read only memory 940, a mass storage device 950, communication port 960, and a processor 970. A person skilled in the art will appreciate that the computer system 900 may include more than one processor and communication ports. The processor 970 may include various modules associated with embodiments of the present disclosure. The communication port 960 can be any of Recommended Standard (RS)-232 port for use with a modem-based dialup connection, a 10/100 Ethernet port, a Gigabit or 10 Gigabit port using copper or fiber, a serial port, a parallel port, or other existing or future ports. The communication port 960 may be chosen depending on a network, such a Local Area Network (LAN), Wide Area Network (WAN), or any network to which computer system connects. The memory 930 can be Random Access Memory (RAM), or any other dynamic storage device commonly known in the art. The Read-only memory 940 can be any static storage device(s) e.g., but not limited to, a Programmable Read Only Memory (PROM) chips for storing static information for the processor 970. The mass storage 950 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

The bus 920 may be communicatively coupled to the processor(s) 970 with the other memory, storage and communication blocks. The bus 920 can be, e.g., a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects the processor 970 to software system.

Optionally, operator and administrative interfaces, e.g., a display, keyboard, and a cursor control device, may also be coupled to the bus 920 to support direct operator interaction with a computer system. Other operator and administrative interfaces can be provided through network connections connected through the communication port 960. The external storage device 910 can be any kind of external hard-drives, floppy drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

The computing system 900 may also include a quantum computing system 980. The quantum computing system 980 may be communicatively coupled with the classical computing system 905. The classical computing system 905 may be configured to transmit instructions and/or data for computation of one or more tasks. The classical computing system 905 may be configured to encode the instructions and/or data in formats compatible with the quantum computing system 980, and may be configured to decode measurements or processed data from the quantum computing system 980. In some embodiments, the quantum computing system 980 may be external to the classical computing system 905. In other embodiments, the quantum computing system 980 may be integrated with the classical computing system 905.

In some embodiments, a system for determining solutions to queries, comprises a processor; and a memory coupled to the processor, wherein the memory comprises one or more processor-executable instructions that cause the processor to: define one or more particles to represent one or more artifacts associated with one or more queries, wherein each of the one or more particles comprises: one or more quantum properties that are configured to be in a superposition of one or more possible classical values in a corresponding configuration space; and one or more entanglements assigned to each possible classical value of the one or more quantum properties, wherein applying the one or more entanglements either expands or constrains the configuration space, wherein the one or more quantum properties are collapsible into at least one permutation from a set of permutations of one or more classical values from the configuration space based on the one or more entanglements; store the one or more particles for unification the one or more quantum properties into the at least one permutation; and actualization of the one or more artifacts based on the at least one permutation.

In another embodiment, a non-transitory computer readable medium, comprises processor executable instructions to: define one or more particles to represent one or more artifacts associated with one or more queries, wherein each of the one or more particles comprises: one or more quantum properties that are configured to be in a superposition of one or more possible classical values in a corresponding configuration space; one or more entanglements assigned to each possible classical value of the one or more quantum properties, wherein applying the one or more entanglements either expands or constrains the configuration space, wherein the one or more quantum properties are collapsible into at least one permutation from a set of permutations of one or more classical values from the configuration space based on the one or more entanglements; and store/transmit the one or more particles for unification the one or more quantum properties into the at least one permutation and actualization of the one or more artifacts based on the at least one permutation.

In another embodiment, a method for unification of particles corresponding to a high-level user request, comprises receiving with a processor a request from a user for unification of one or more predefined particles associated with one or more activities on a target domain, wherein the request comprises one or more anterior logical entanglements associated with one or more first quantum properties of the one or more predefined particles; identifying with the processor one or more transitive entanglements corresponding to dependencies of each of the one or more predefined particles based on the one or more anterior logical entanglements, wherein the one or more transitive entanglements entangle at least one possible classical value associated with the one or more first quantum properties to one or more second quantum properties associated with one or more dependency particles; unifying with the processor the one or more predefined particles and the one or more dependency particles to determine a permutation of one or more classical values for the one or more first quantum properties and the one or more second quantum properties; and actualizing into a software package with the processor the one or more predefined particles and the one or more dependency particles in the target domain based on the permutation.

One or more possible classical values of the one or more second quantum properties may have further transitive entanglements with other dependency particles. The one or more first quantum properties and the one or more second quantum properties may be in a state of superposition until the one or more corresponding predefined particles or the one or more corresponding dependency particles are collapsed during unification.

Pursuant to the method, identifying the one or more dependency particles may comprise: generating a unification requirement tree comprising: one or more anterior dependency nodes corresponding to the one or more anterior logical entanglements associated with a specified target domain; one or more transitive dependency nodes corresponding to the one or more transitive entanglements associated with each of the one or more predefined particles, the one or more transitive dependency nodes being derived from the one or more anterior dependency nodes; and one or more specific value nodes corresponding to one or more possible classical values for the one or more first quantum properties and the one or more second quantum properties. The method may include generating a dependency graph based on the unification requirement tree.

Pursuant to the method, the one or more transitive dependency nodes may comprise a conditional logical entanglement from the one or more transitive logical entanglement, wherein the conditional entanglement node corresponds to at least one transitive logical entanglement that applies when the one or more first quantum properties or the one or more second quantum properties are equal to a predefined classical value or are within a predefined classical range.

The instructions for generating the unification requirement tree may comprise, for each anterior dependency node in the one or more anterior dependency nodes, recursively expanding the one or more transitive dependency nodes and/or the one or more anterior dependency nodes to identify other transitive dependency nodes that the one or more transitive dependency nodes and/or the one or more anterior dependency nodes are dependent on.

Recursively expanding the one or more transitive dependency nodes may comprises, for a transitive dependency node that was expanded during a previous recursion, associating a cloneable passive node to the transitive dependency node. Each of the one or more specific value nodes may be further associated with other transitive dependency nodes.

The method may comprise determining compatibility between the one or more specific value node with a specific target domain; and when the one or more specific value nodes are compatible, resolving the one or more specific value nodes to the specific target node, and when the one or more specific value nodes are not compatible, resolving the one or more specific value nodes to another target domain. For generating the dependency graph, the method may comprise connecting each child dependency node and with a corresponding parent dependency node using an edge to represent dependency therebetween, wherein the child dependency nodes and the parent dependency nodes are obtained from the unification requirement tree. The dependency graph may be a directed graph.

Unifying the one or more predefined particles and the one or more dependency particles, may comprise generating a set of permutations of one or more possible classical values for the one or more first quantum properties and the one or more second quantum properties, wherein the set of permutations are cartesian products of each of the one or more first quantum properties and the one or more second quantum properties based on a plurality of entanglements identified in a dependency graph, pruning the set of permutations that are inconsistent with the one or more anterior logical entanglements or the one or more transitive entanglements, and incrementally collapsing the one or more predefined particles and the one or more dependency particles to obtain the permutation.

The the set of permutations may be produced using one or more posterior logical entanglements. For unifying the one or more predefined particles and the one or more dependency particles, the method may comprise generating a particle entanglement map representing the one or more anterior logical entanglements and the one or more transitive logical entanglements associated with one or more possible classical values corresponding to each of the one or more first quantum properties and the one or more second quantum properties; and incrementally collapsing the one or more predefined particles and the one or more dependency particles to obtain the permutation, wherein the one or more anterior logical entanglements and the one or more transitive logical entanglements associated with the one or more possible classical values are retrieved from the particle entanglement graph.

For unifying the one or more predefined particles and the one or more dependency particles the method may comprise determining at least one validating classical value for at least one quantum property from the one or more first quantum properties and the one or more second quantum properties based on the one or more anterior entanglements and/or the one or more transitive entanglements; generating a set of permutations, wherein the set of permutation comprises permutations where the at least one quantum property is collapsed to the at least one validating classical value; and incrementally collapsing the one or more predefined particles and the one or more dependency particles to obtain the permutation from the set of permutations.

For incrementally collapsing the one or more predefined particles and the one or more dependency particles, the method may comprise locally collapsing a next quantum property from the one or more first quantum properties or the one or more second quantum properties based on the next quantum property having a set of predicating entanglements associated with the at least one quantum property. The set of predicating entanglements may comprise at least one logical entanglement from the one or more transitive entanglements or the anterior logical entanglements that entangle the next quantum property with the at least one classical value of the at least one quantum property are in a collapsed state.

When incrementally collapsing the one or more predefined particles provides an under-constrained set of permutations, the method may comprise critically constraining the set of permutations based on at least one of: a user selection received from the user, wherein the user selection is converted into an anterior logical entanglement; a heuristic selection determined either by the user or by a developer entity associated with the one or more particles; and/or random selection.

For unifying the one or more predefined particles and the one or more dependency particles the method may comprise determining at least one non-validating classical value for at least one quantum property from the one or more first quantum properties and the one or more second quantum properties based on the one or more anterior entanglements and/or the one or more transitive entanglements; generating a set of permutations, wherein the set of permutation comprises permutations where the at least one quantum property is not collapsed to the at least one non-validating classical value; and incrementally collapsing the one or more predefined particles and the one or more dependency particles to obtain the permutation from the set of permutations.

The method may further comprise actualizing the one or more predefined particles and the one or more dependency particles based on satisfaction of one or more corresponding policy requirements.

In one embodiment, a system for unification of particles corresponding to a high-level user request, comprises a processor; and a memory coupled to the processor. The memory comprises one or more processor-executable instructions that cause the processor to receive a request from a user for unification of one or more predefined particles associated with one or more activities on a target domain, wherein the request comprises one or more anterior logical entanglements associated with one or more first quantum properties of the one or more predefined particles; identify one or more transitive entanglements corresponding to dependencies of each of the one or more predefined particles based on the one or more anterior logical entanglements, wherein the one or more transitive entanglements entangle at least one possible classical value associated with the one or more first quantum properties to one or more second quantum properties associated with one or more dependency particles; unify the one or more predefined particles and the one or more dependency particles to determine a permutation of one or more classical values for the one or more first quantum properties and the one or more second quantum properties; and actualize the one or more predefined particles and the one or more dependency particles in the target domain based on the permutation.

In one embodiment a non-transitory computer readable medium includes instructions to: receive a request from a user for unification of one or more predefined particles associated with one or more activities on a target domain, wherein the request comprises one or more anterior logical entanglements associated with one or more first quantum properties of the one or more predefined particles; identify one or more transitive entanglements corresponding to dependencies of each of the one or more predefined particles based on the one or more anterior logical entanglements, wherein the one or more transitive entanglements entangle at least one possible classical value associated with the one or more first quantum properties to one or more second quantum properties associated with one or more dependency particles; unify the one or more predefined particles and the one or more dependency particles to determine a permutation of one or more classical values for the one or more first quantum properties and the one or more second quantum properties; and actualize the one or more predefined particles and the one or more dependency particles in the target domain based on the permutation.

It may be appreciated by those skilled in the art that many uses of the present disclosure provide technical contributions to the art, and thus justifies approval of the claims. For example, where the user is a professional software developer, the present disclosure may be viewed as software automation of tasks that may be performed manually, in a computationally and memory efficient manner. In other examples, other users of the system of the present disclosure include non-professional non-subject matter expert users, who do not have the expertise to perform the steps manually, and uses the system to construct new artifacts/apparatus/systems involving signals and hardware capabilities together,, such as for construction of snap-fit designs, tool-less assembly mechanisms, self-aligning features, integrated fasteners, modular design systems, pre-assembled subcomponent systems, simplified joint designs, assembly jigs and fixtures, or color-coded or keyed components, thereby providing technical character to embodiments provided in the present disclosure.

While considerable emphasis has been placed herein on the preferred embodiments, it will be appreciated that many embodiments can be made and that many changes can be made in the preferred embodiments without departing from the principles of the present disclosure. These and other changes in the preferred embodiments of the present disclosure will be apparent to those skilled in the art from the disclosure herein, whereby it is to be distinctly understood that the foregoing descriptive matter to be implemented merely as illustrative of the present disclosure and not as limitation.

If the specification or claims refer to “an additional” element, that does not preclude there being more than one of the additional elements.

It is to be understood that where the claims or specification refer to “a” or “an” element, such reference is not to be construed that there is only one of that elements.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the present disclosure is not limited to those diagrams or to the corresponding descriptions. For example, flow need not move through each illustrated box or state, or in exactly the same order as illustrated and described.

Methods of the present disclosure may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the present disclosure belongs.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present disclosure is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

What is claimed is:

1. A system for representing aspects of artifacts for unification and actualization of the artifacts, comprising:
a processor;
a memory accessible by the processor and containing processor executable instructions for:
defining, by a processor, one or more particles to represent one or more artifacts associated with one or more queries, wherein each of the one or more particles comprises:
one or more quantum properties that are configured to be in a superposition of one or more possible classical values in a corresponding configuration space;
one or more entanglements assigned to each possible classical value of the one or more quantum properties, wherein applying the one or more entanglements either expands or constrains the configuration space;
wherein the one or more quantum properties are collapsible into at least one permutation from a set of permutations of one or more classical values from the configuration space based on the one or more entanglements;
storing the one or more particles for unification of the one or more quantum properties into the at least one permutation; and
actualization of the one or more artifacts into a software package based on the at least one permutation.

2. The system of claim 1, wherein the one or more entanglements between the one or more quantum properties of the one or more particles are provided by a developer entity.

3. The system of claim 1, wherein the one or more entanglements corresponding to each possible classical value of a first quantum property entangle the possible classical value to a second quantum property.

4. The system of claim 3, wherein the first quantum property and the second quantum property are associated with different particles.

5. The system of claim 1, wherein the memory further contains processor executable instructions for assigning one or more policy requirements to the one or more particles, wherein the one or more particles are actualizable on satisfaction of the one or more policy requirements.

6. The system of claim 1, wherein the memory further contains processor executable instructions for deploying the one or more particles in a two-sided platform.

7. The system of claim 1, wherein defining the one or more particles comprises translating metadata associated with the one or more artifacts that are predefined into the one or more particles.

8. A method for unification of particles corresponding to a high-level user request, comprising:
receive with a processor a request from a user for unification of one or more predefined particles associated with one or more activities on a target domain, wherein the request comprises one or more anterior logical entanglements associated with one or more first quantum properties of the one or more predefined particles;
identify with the processor one or more transitive entanglements corresponding to dependencies of each of the one or more predefined particles based on the one or more anterior logical entanglements, wherein the one or more transitive entanglements entangle at least one possible classical value associated with the one or more first quantum properties to one or more second quantum properties associated with one or more dependency particles;
unify with the processor the one or more predefined particles and the one or more dependency particles to determine a permutation of one or more classical values for the one or more first quantum properties and the one or more second quantum properties; and
actualize into a software package with a processor the one or more predefined particles and the one or more dependency particles in the target domain based on the permutation.

9. The method of claim 8, wherein one or more possible classical values of the one or more second quantum properties have further transitive entanglements with other dependency particles.

10. The method of claim 8, wherein the one or more first quantum properties and the one or more second quantum properties are in a state of superposition until the one or more corresponding predefined particles or the one or more corresponding dependency particles are collapsed during unification.

11. The method of claim 8, wherein identifying the one or more dependency particles comprises:
generating a unification requirement tree comprising:
one or more anterior dependency nodes corresponding to the one or more anterior logical entanglements associated with a specified target domain,
one or more transitive dependency nodes corresponding to the one or more transitive entanglements associated with each of the one or more predefined particles, the one or more transitive dependency nodes being derived from the one or more anterior dependency nodes,
one or more specific value nodes corresponding to one or more possible classical values for the one or more first quantum properties and the one or more second quantum properties;
and generating a dependency graph based on the unification requirement tree.

12. The method of claim 11, wherein the one or more transitive dependency nodes comprise a conditional logical entanglement from the one or more transitive logical entanglement, wherein the conditional entanglement node corresponds to at least one transitive logical entanglement that applies when the one or more first quantum properties or the one or more second quantum properties are equal to a predefined classical value or are within a predefined classical range.

13. The method of claim 11, wherein the instructions for generating the unification requirement tree comprise, for each anterior dependency node in the one or more anterior dependency nodes, recursively expanding the one or more transitive dependency nodes and/or the one or more anterior dependency nodes to identify other transitive dependency nodes that the one or more transitive dependency nodes and/or the one or more anterior dependency nodes are dependent on.

14. The method of claim 13, wherein recursively expanding the one or more transitive dependency nodes comprises, for a transitive dependency node that was expanded during a previous recursion, associating a cloneable passive node to the transitive dependency node.

15. The method of claim 11, wherein each of the one or more specific value nodes are further associated with other transitive dependency nodes.

16. The method of claim 11, further comprising:
determining compatibility between the one or more specific value node with a specific target domain; and
when the one or more specific value nodes are compatible, resolving the one or more specific value nodes to the specific target node, and
when the one or more specific value nodes are not compatible, resolving the one or more specific value nodes to another target domain.

17. The method of claim 11, wherein for generating the dependency graph, the method comprises:
connecting each child dependency node and with a corresponding parent dependency node using an edge to represent dependency therebetween, wherein the child dependency nodes and the parent dependency nodes are obtained from the unification requirement tree.

18. The method of claim 11, wherein the dependency graph is a directed graph.

19. The method of claim 8, wherein for unifying the one or more predefined particles and the one or more dependency particles, the method comprises:
generating a set of permutations of one or more possible classical values for the one or more first quantum properties and the one or more second quantum properties, wherein the set of permutations are cartesian products of each of the one or more first quantum properties and the one or more second quantum properties based on a plurality of entanglements identified in a dependency graph;
pruning the set of permutations that are inconsistent with the one or more anterior logical entanglements or the one or more transitive entanglements; and
incrementally collapsing the one or more predefined particles and the one or more dependency particles to obtain the permutation.

20. The method of claim 19, wherein the set of permutations are produced using one or more posterior logical entanglement.
